(19) United States
(12) Patent Application Publication
(10) Pub. No.: US 2024/0011952 A1
(43) Pub. Date: Jan. 11, 2024

(54) MULTIDIMENSIONAL LC SYSTEM FOR ANALYSING ANTIBODIES

(71) Applicant: Hoffmann-La Roche Inc., Little Falls, NJ (US)

(72) Inventors: Saban ÖZIPEK, Basel (CH); Anja BATHKE, Basel (CH); Sina Nadine HÖLTERHOFF, Basel (CH)

(21) Appl. No.: 18/336,422

(22) Filed: Jun. 16, 2023

Related U.S. Application Data
(60) Provisional application No. 63/353,450, filed on Jun. 17, 2022.

(51) Int. Cl. G01N 30/32; G01N 1/40; G01N 30/36; G01N 30/60

(52) U.S. Cl. CPC G01N 30/32; G01N 1/4044; G01N 30/36; G01N 30/6039; G01N 2030/027

(57) ABSTRACT

The present application is directed to multidimensional liquid chromatography (LC) systems. In certain aspects, provided is a multidimensional LC system comprising a digestion module having a digestion column containing an immobilized proteolytic enzyme, a trapping module having a trapping column for holding the sample after digestion in the digestion module, and a separation module having a separation column for separating analytes in the sample after release of the sample from the trapping column. In certain aspects, in the direction of flow through the LC systems described herein, the modules are in the following order: digestion module; trapping module, and then separation module.

### CROSS-REFERENCE TO RELATED APPLICATIONS

This application claims the benefit and priority to U.S. Provisional Application No. 63/353,450, filed on Jun. 17, 2022, the contents of which are hereby incorporated by reference herein in their entirety for all purposes.

### BACKGROUND

Therapeutic monoclonal antibodies (mAbs) have become increasingly important for the treatment of critical diseases. To ensure patient safety it is crucial that quality control confirms the reliability and consistency of biopharmaceutical products such as mAbs across the entire product life cycle.

For example, protein stability has to be maintained from production until application, to assure a safe and efficacious treatment of patients. To provide sufficient quality of biopharmaceutical products, the U.S. Food and Drug Administration (FDA) recommends characterization and monitoring of critical quality attributes (CQAs) directly at the peptide level. To comply with the requirements, peptide mapping analysis has become a standard method for characterizing the primary structure of biopharmaceuticals and thus the accurate identification of post-translational modifications (PTMs).

The chemical amino acid modifications of therapeutic antibodies have been extensively investigated and reviewed. The most common degradations are oxidation of methionine and tryptophan, deamidation of asparagine, isomerization of aspartate, and glycation of lysine residues.

Monitoring of these modifications is important, because they show altered stability as well as an impact on biological function. This is especially the case for deamidation of asparagine residues located in the complementarity-determining regions (CDRs) and methionine oxidation as oxidization of monoclonal antibodies (mAbs) is known to influence in vivo product stability, receptor binding, and structure and exhibit accelerated plasma clearance.

Normally, characterization of mAb modifications is a time consuming and multistep offline process, where the samples are fractionated, reduced, and alkylated followed by tryptic digestion for several hours. Each of these steps requires separate manual intervention with the associated decrease in efficiency To increase efficiency, approaches towards automating some (or all) of the characterization process have been developed.

One approach involves automating the manual sample preparation with pipetting robots, allowing simultaneous processing of multiple samples in 96-well plates.

Another approach involves automated sample preparation and peptide mapping analysis by liquid chromatography (LC) based methods. In these cases the sample is injected directly into a multidimensional LC-system (mD-LC) and the sample is processed and analyzed in an automated manner.

An advantage to LC based methods is that they can combine chromatographic steps (e.g. ion exchange chromatography (IEC), size exclusion chromatography (SEC), Protein-A), reductions steps or digestion steps as needed prior to peptide mapping in an automated manner.

The different steps are referred to as “dimensions”. The combinations of possible dimensions opens up a wide range of possibilities for system expansion and specific applications for the pharmaceutical industry.

Known multidimensional LC based methods include those disclosed by Gstöttner et al. (Gstöttner, C.; Klemm, D.; Haberger, M.; Bathke, A.; Wegele, H.; Bell, C.; Kopf, R., Fast and automated characterization of antibody variants with 4D HPLC/MS. Analytical chemistry 2018, 90 (3), 2119-2125) for the analysis and characterization of mAb degradation products. The process and apparatus developed by Gstöttner is a multidimensional-LC system (mD-LC) coupled to a high-resolution mass spectrometer.

Gstöttner's four-dimensional LC-MS/MS system (referred to herein as “4D-HPLC/MS”) incorporates ion exchange chromatography (IEC) as the first dimension (¹D) and allows online fractionation of charge variants using a multiple heart cutting valve (MHC). The subsequent three dimensions after fractionation are reduction, digestion and peptide mapping prior to MS-analysis (²D=reduction, ³D=Trypsin digestion, ⁴D=peptide mapping). Using their system the characterization of 5 charge variants can be performed about 5.8 times faster than manual characterization (online 9h vs. offline 52h) demonstrating the potential for such ‘online’ systems.

However, there are drawbacks to current automated systems. The use of a digestion columns to prepare samples for mapping (also referred to as immobilized bioreactors or IMERs) require pressure of the system to be controlled. These standard digestion columns cannot tolerate pressure above ˜170 bar. Downstream processes in multidimensional LC systems contain IMERs are restricted in terms of the pressure that can be used to avoid large backpressures damaging the IMERs.

The state of the art peptide mapping columns used in the time consuming, and typically more accurate, manual processes for analyzing mAbs are ultrahigh performance (UHPLC) columns. UHPLC columns typically operate at high pressures (up to 1300 bar) and require these high pressures to provide good peak separation and hence characterization of the sample.

UHPLC or other columns requiring higher pressures to operate in an optimal manner cannot be used for peptide mapping in the automated systems described by Gstöttner et al. and other known multidimensional LC systems due to the presence of IMERs in those systems.

Additionally, known LC based methods generally provide reduced sequence coverage compared to the manual process. This is clearly a draw back in a process that is intended to verify the safety of a pharmaceutical product. For example, the results from Gstöttner et al.'s process do not detect some small, polar peptides (<1.3 kDa) which results in a reduced sequence coverage (online: LC: 94%, HC: 86% vs. offline: LC: 94%, HC: 94%). The loss of small, polar peptides while peptide mapping analysis may be importantly for example if they are declared as CQAs.

Multidimensional LC instruments can enable rapid and automated characterization of biopharmaceuticals with the ability to online fractionate from various 1D chromatographic methods. Depending on the first dimension, these versatile systems have the potential to support in multiple phases of mAb process-, drug- and formulation development.

The present invention aims to solve one or more of the above problems. In particular, the present invention provides a multidimensional LC system that is not restricted in terms of the separation columns that can be used and allows the use of UHPLC columns for peptide mapping. The present invention may also provide increased sequence coverage and detection of small polar peptides.

### SUMMARY OF INVENTION

The present invention provides a multidimensional liquid chromatography (LC) system for characterizing a sample of therapeutic antibodies. The system comprises a digestion module having a digestion column containing an immobilized proteolytic enzyme, a trapping module having a trapping column for holding the sample after digestion in the digestion module, and a separation module having a separation column for separating analytes in the sample after release of the sample from the trapping column. In the direction of flow through the LC system, the modules are in the following order: digestion module; trapping module, and then separation module. Preferably the separation column is a peptide mapping column.

The system also comprises a first valve assembly; and a second valve assembly. The first valve assembly and the second valve assembly are configured such that the digestion column and the trapping column are fluidly connectable; the trapping column and the separation column are fluidly connectable; and the separation module and the digestion module are not fluidly connectable.

In some embodiments, the first valve assembly comprises a plurality of ports configured so that some combinations of the plurality of ports can be fluidly connected in a first position of the first valve assembly and other combinations of the plurality of ports can be fluidly connected in a second position of the first valve assembly; and the second valve assembly comprises a plurality of ports configured so that some combinations of the plurality of ports can be fluidly connected in a first position of the second valve assembly and other combinations of the plurality of ports can be fluidly connected in a second position of the second valve assembly. In this embodiment, the digestion column and the trapping column are fluidly connected when the first valve assembly is in the second position and the second valve assembly is in a first position. The trapping column and the digestion column are not fluidly connected in any other combination of positions of the valve assemblies. The trapping column and the separation column are fluidly connected when the second valve assembly is in a second position. The trapping column and the separation column are not fluidly connected in any other combination of positions of the valve assemblies. The separation module and the digestion module are not fluidly connected in any combination of positions of the valve assemblies.

Using the system of the invention a sample to be analyzed can be digested using the digestion module and then fed onto the trapping column in the trapping module. The sample can be held on the trapping column before switching one or both of the first and second valve assembly to fluidly connect the trapping column and the separation column, for example, by switching the position of the second valve assembly to the first position from the second position.

Switching the position of the valve assemblies to fluidly connect the different modules means that it is possible to prevent the digestion module experiencing backpressure from the separation module. This allows the separation module to include a separation column that operates at a high pressure without damaging the digestion column. The un-coupling of the digestion module and the separation module in the system of the present invention allows high performance peptide mapping columns which generally require high pressures to be used in an automated process.

Put another way, the multidimensional liquid LC system of the invention allows a free column selection such that, for example, in peptide mapping analysis UHPLC-columns (≤1300 bar), can be used. Additionally, this allows the transfer of established, routine manual UHPLC-MS peptide mapping methods onto a multidimensional system to carry out the process in an automated fashion.

In some embodiments, the trapping module comprises a trapping pump and the trapping pump is fluidly connected to the trapping column when the first valve assembly is in the first position and the second valve assembly is in the first position. The trapping column is not fluidly connected to the digestion module or the separation module in this configuration.

Switching the first valve assembly from the second position the first position after the digested sample is trapped on the trapping column means that the trapping module can flush the trapping column to remove salts used in the digestion module and may allow the solvent composition of the sample on the trapping column to be adjusted, for example, to reduce the acetonitrile concentration and equilibrate the sample before it is run through the separation module. In this way, improved separation on the separation column can be achieved.

In some embodiments the multidimensional LC system further comprises a reduction module having a reduction column. The reduction module and the digestion module are fluidly connected when the digestion module and the trapping module are fluidly connected for example, when the first valve assembly is in the second position.

In this way, the sample to be analyzed can be reduced before digestion and trapping allowing additional steps to be carried out online or in an automated manner.

In some embodiments the multidimensional LC system further comprises a fractionation module having a fractionation column.

In this way, the sample to be analyzed can be fractionated in an initial chromatography step.

The fractions can each then be further processed by the digestion module, trapping module and separation module and optionally, when present, the reduction module.

Preferably, a multiple heart cutting valve is fluidly connected to the fractionation column. The multiple heart cutting valve is after the fractionation column in the direction of flow. The multiple heart cutting valve allows the collection of sample fractions of the outflow from the fractionation column each of the fractions can then be processed in the remaining system to analyze their content.

The present invention also provides a multidimensional LC process for analyzing a sample of therapeutic antibodies. The process comprises the steps of;
providing a sample of antibodies to be analyzed,
introducing the sample to a digestion module having a digestion column containing an immobilized proteolytic enzyme, such that the enzyme proteolytically cleaves the antibodies in the sample to produce a digested sample,
introducing the digested sample to a trapping column for holding the digested sample, and
releasing the digested sample from the trapping column and introducing the sample to a separation module having a separation column for separating analytes in the sample,

The sample is flowed through the digestion module, trapping module and separation module using solvent and one or more pumps.

In the process a first valve assembly and a second valve assembly are used to: provide fluid connection between the digestion module and the trapping module when the sample is digested and trapped on the trapping column; and provide fluid connected between the trapping column and separation column when the digested sample is released from the trapping column and introduced onto the separation column; and prevent fluid connection between the separation column and digestion column.

### BRIEF DESCRIPTION OF THE FIGURES

FIG. 1 shows a schematic illustration of the mD-UHPLC/MS workflow: First dimension (¹D): Ion-exchange chromatography or size-exclusion chromatography with multiple heart cutting (MHC) online fractionation; Second dimension (²D): On-column reduction; Third dimension (³D): On-column digestion by immobilized enzyme reactor 1 and/or 2 (IMER); Fourth dimension (⁴D): Peptide trapping and desalting; Fifth dimension (⁵D): Peptide mapping analysis with high-resolution mass spectrometer (Impact II, Bruker Daltonics); B Schematic diagram of the mD-UHPLC/MS system with all LC capillaries illustrated as colored lines: MHC=multiple heart cutting valve with loop deck A and B. Each deck incorporates six loops with either 40 μL or 120 μL volume for online fractionation; CC1/CC2=column compartment (oven); IMER1=Trypsin immobilized enzyme reactor; IMER2=LysC immobilized enzyme reactor; V1/V2=2-position/10-port valve; Mixer 1=bioinert 100 μL static mixer; Mixer 2=bioinert 150 μL static mixer; C Illustration of the three different digestion configurations of the mD-UHPLC/MS instrument. The figure was created with BioRender.com.

FIG. 2 shows a system comparison mD-UHPLC-MS/MS vs 4D HPLC/MS: A: Sequence coverage comparison of the main peak fraction of Herceptin® (Trastuzumab) obtained with the 4D-HPLC-MS system published by Gstöttner et al. (2018) and the mD-UHPLC/MS system. In addition, the acetonitrile concentration during the peptide trapping step is illustrated for the two systems; B: Base peak chromatogram (BPC) of the main peak cation-exchange chromatography (CEX) fraction of Trastuzumab analyzed with the mD-UHPLC/MS instrument. For the analysis 50 μg were injected into the system and the Agilent InfinityLab Poroshell 120 SB-C18, 3.0×5 mm, 1.9 μm pre column was used in combination with the Agilent InfinityLab Poroshell 120 SB-C18 2.1×150 mm, 1.9 μm analytical UHPLC column; C: Extracted ion chromatograms of three small peptides, which are not detected with the 4D-HPLC-MS system by Gstöttner et al. (2018): blue=CDR H2 peptide YADSVK, green=glycopeptide EEQYNSTYR, orange=oxidized peptide=DTLMISR. Post-translational modified peptides are highlighted in red; D: Corresponding MS spectra for the three small peptides: blue: theoretical mass=681.3334 Da, mass error=1.03 ppm; green: theoretical mass=2633.0386 Da, mass error=0.46 ppm; orange: theoretical mass

FIG. 3 shows a comparison mD-UHPLC-MS/MS system with recent mD-LC-MS instruments: Illustrated is the CEX chromatogram of Herceptin® with the mD-UHPLC-MS/MS system. The absorbance was measured at 214 nm and for the analysis 150 μg of Herceptin® were injected. The analyzed fractions are indicated as red bars with the identified Herceptin® species displayed on top. For the indicated Herceptin® species, the mean of the relative quantification is shown in percent. In addition, the online sample preparation time for each fraction of the mD-UHPLC-MS/MS system and the 4D-HPLC/MS instrument is displayed below. The figure was in part created with BioRender.com.

FIGS. 4A-4C show an analysis of ethylene oxide stressed bispecific antibody with the mD-UHPLC-MS/MS system: FIG. 4A: Chromatograms of the ¹D CEX analyzing a bispecific antibody (provided by F. Hoffmann la Roche LTD, Basel CH) with the mD-UHPLC-MS/MS system. The absorbance was measured at 280 nm and for the analysis 200 μg of BsMAb were injected. Blue line=BsMAb sample incubated 7 days at 30° C., orange line=BsMAb sample incubated with 0.01% ethylene oxide for 7 days at 30° C. The fractionated and analyzed fractions are indicated as red bars with the identified BsMAb species displayed on top; FIG. 4B: Extracted ion chromatogram and MS spectra of the T19 HC1/T23 HC2 tryptic peptide (orange) and the corresponding ethylene oxide adduct (green); FIG. 4C: Extracted ion chromatogram and MS spectra of the L16 HC1/L17 HC2 LysC peptide (orange) and the corresponding ethylene oxide adduct (green). The figure was in part created with BioRender.com.

### DETAILED DESCRIPTION

The present invention provides a multidimensional liquid chromatography (LC) system for characterizing a sample of therapeutic antibodies. The system comprises a digestion module having a digestion column containing an immobilized proteolytic enzyme, a trapping module having a trapping column for holding the sample after digestion in the digestion module, and a separation module having a separation column for separating analytes in the sample after release of the sample from the trapping column. In the direction of flow through the LC system, the modules are in the following order: digestion module; trapping module, and then separation module. Preferably the separation column is a peptide mapping column.

“Liquid chromatography” or “LC” is an analytical process that subjects sample to chromatographic separation through an LC column in order, for example, to separate analytes of interest from matrix components. Samples may be injected by a sample injector. “High-performance liquid chromatography” or HPLC, “ultra-high-performance liquid chromatography” or UHPLC, including “micro liquid chromatography” or μLC and “small-bore liquid chromatography” or small-bore LC are forms of liquid chromatography performed under pressure.

A “liquid chromatographic system or LC system” is an analytical apparatus or a unit in an analytical apparatus for carrying out liquid chromatography. The LC system may also comprise elements such as a sample injector, valves, liquid sources, fluidic connections e.g., for mixing liquids, degassing liquids, tempering liquids, and the like, one or more sensors, such as pressure sensors, temperature sensors and the like, and especially at least one LC pump. The list is not exhaustive. According to an embodiment, the LC system of the invention is an analytical apparatus designed to prepare a sample for mass spectrometry and/or to transfer a prepared sample to a mass spectrometer, in particular for separating analytes of interest before detection by a mass spectrometer.

A “multidimensional LC system” refers to an LC system as defined herein in which multiple modules are combined. Each module is referred to as a dimension. Each module contains a column through which the sample is passed. Different types of columns can be used in different modules to provide a sequence of chromatography and treatment, e.g. reduction or digestion, steps in a single ‘run’ through the LC system. Each module may also comprise components such as a pump and waste outflow. Generally, multidimensional LC systems also have a number of valve assemblies for connecting the different modules at different times.

A “column” refers to any of a column, a cartridge, a capillary and the like that are suitable for performing chromatography or performing a reaction such as digestion on a substance that is passed through the column. Preferably the column is a column. Columns are typically packed or loaded with a stationary phase, through which a mobile phase is pumped in order to trap and/or separate and elute and/or transfer analytes of interest under selected conditions, e.g., according to their polarity or log P value, size or affinity, as generally known. This stationary phase can be particulate or beadlike or a porous monolith. Columns may be exchangeable and/or operate in parallel or in sequence to one or more other columns.

The term “sample” refers to a material suspected of containing one or more analytes of interest. In the present case, the sample is preferably a sample of antibodies for analysis. The sample can be pre-treated prior to use. Methods of treatment can involve filtration, centrifugation, distillation, concentration, inactivation of interfering components, and the addition of reagents.

Some features of the system of the invention are defined in terms of their position relative to the direction of flow. The direction of flow in this case refers to the flow of liquid, e.g. solvent, through the system during operation. For example if component A is ‘after’ component B in the direction of flow, the liquid, e.g. solvent, will pass through component B before component A during operation of the system.

The system also comprises a first valve assembly; and a second valve assembly. The first valve assembly and the second valve assembly are configured such that the digestion column and the trapping column are fluidly connectable; the trapping column and the separation column are fluidly connectable; and the separation module and the digestion module are not fluidly connectable.

In some embodiments, the first valve assembly comprises a plurality of ports configured so that some combinations of the plurality of ports can be fluidly connected in a first position of the first valve assembly and other combinations of the plurality of ports can be fluidly connected in a second position of the first valve assembly; and the second valve assembly comprises a plurality of ports configured so that some combinations of the plurality of ports can be fluidly connected in a first position of the second valve assembly and other combinations of the plurality of ports can be fluidly connected in a second position of the second valve assembly. In this embodiment, the digestion column and the trapping column are fluidly connected when the first valve assembly is in the second position and the second valve assembly is in a first position. The trapping column and the digestion column are not fluidly connected in any other combination of positions of the valve assemblies. The trapping column and the separation column are fluidly connected when the second valve assembly is in a second position. The trapping column and the separation column are not fluidly connected in any other combination of positions of the valve assemblies. The separation module and the digestion module are not fluidly connected in any combination of positions of the valve assemblies.

A “valve assembly” refers to a multi-port valve component that controls flow between elements connected to the ports. This is typically achieved by a switch mechanism that moves one or more valve conduits to switch communication between different elements. Elements, e.g. components of one or more of the modules, may be fluidically connected to the ports via further conduits, like pipes, tubes, capillaries, microfluidic channels and the like and by fittings like screws/nuts and ferrules, or alternative liquid-tight sealings, e.g., maintained in place by a clamp mechanism. In this way, the various components of the modules may be connected as defined herein. For example, the pump of the trapping module may be connected to the trapping column via the first valve assembly.

The first and second valve assembly may be any a multiport valve with from a 2-7 way switching, preferably 2 way switching.

The first and second valve assembly may be a multiport valve with any of 10, 12, or 14 port valves. Preferably the first valve assembly is a 10 port valve with 2 way switching. Preferably, the second valve assembly is a 10 port valve with 2 way switching.

In this way, the number of valves can be reduced compared to prior art systems, and the un-coupling of the digestion modules and the separation modules is achieved using a simplified system. The simplified system makes operation of the multidimensional LC system of the invention simpler and controllable using standard software.

In some embodiments, the multidimensional LC system of the invention further comprising an analysis module for analyzing the sample after the sample has passed through the separation column. The analysis module may comprise: a mass spectrometer such as a high-resolution mass spectrometer (HRMS) or a Single Quad mass spectrometer; an evaporative light scattering detector (ELSD): a UV detector; or a diode array detector (DAD).

In some embodiments, the multidimensional LC system of the invention further comprising and injection module for injecting the sample in the system. The injection module may comprise an autosampler, or a direct injector In some embodiments, the injection module may further comprise a bioreactor for preparing the sample to be analyzed. In some embodiments, the injection module is part of the fractionation module. For example, the injection module and the fractionation module combined may be a PAT fractionation module or an autosampler fractionation module.

In some embodiments, the multidimensional LC system further comprises at least one column oven. In this way, the temperature of one or more of the components can be controlled. Preferably, the multidimensional LC system comprises at least two column ovens. A first column oven can house the first valve assembly, the digestion columns and if present the fractionation column. A second column oven can house the trapping column, the second valve assembly and the separation column.

Digestion Module

The multidimensional LC system comprises a digestion module having a digestion column containing an immobilized proteolytic enzyme.

In some embodiments, the digestion column is selected from a Trypsin immobilized enzyme reactor or a LysC immobilized enzyme reactor.

In some embodiments, the digestion module has a first mixer such as a static mixer or a zero delay volume T-Piece after the digestion column(s) in the direction of flow. The first mixer may be fluidly connected to the pump of the trapping module when the first valve is in the second position.

In this way, the trapping pump can provide additional solvent to the first mixer which can dilute the digested sample from the digestion column before the sample is passed onto the trapping column. Diluting the digested sample before it flows onto the trapping column can allow greater retention of the analytes of interest on the trapping column as the solvent can be chosen to ensure maximum retention. For example, in the case of peptides the dilution may involve lowering the acetonitrile concentration to prevent polar peptides from being flushed off the trapping column. The ability to alter the solvent system in this way after digestion facilitates the optimized used of a range of columns for trapping and separation. For example, in the case of trapping and separation using hydrophilic interaction chromatography columns, the solvent can be adjusted to high acetonitrile concentrations before loading onto the trapping column.

In the prior art process for peptide mapping discussed herein, the concentration of acetonitrile is relatively high after digestion. As a result some ‘wanted’ peptides are not retained on the separation column (there is no trapping column in the prior art) and so subsequently these peptides are not analyzed and the sequence coverage is lower. Further dilution in these prior art processes is not possible.

In some embodiments, the digestion module has a second mixer such as static mixer or a zero delay volume T-Piece. In some cases the second mixer is before the digestion column in the direction of flow such that the sample passes through the mixer and is mixed for example with additional solvents to provide a homogenous mixture before entering the digestion column.

In some preferred embodiments, the digestion module comprises two digestion columns. In some such cases the two digestion columns are connected in parallel such that in use the sample flow is split between the two columns.

In some such cases, the two digestion columns are independently selected from a Trypsin immobilized enzyme reactor and a LysC immobilized enzyme reactor, preferably the two digestion columns are a Trypsin immobilized enzyme reactor and a LysC immobilized enzyme reactor.

The parallel digestion setup provides unique peptide combinations for example a unique Trypsin and a LysC peptide can be received. In this way, there is an increased the likelihood of post translational modification (PTM) characterization and the sequence coverage is increased. That is, the system (and process) of the invention using two digestion columns can provide a broader range of digestion products and enable greater sequence coverage. This in-parallel digestion may be particularly advantageous with the increasing number of more complex bispecific mAbs.

In some embodiments the digestion module comprises a digestion pump and the digestion pump is fluidly connected to the digestion column when the first valve assembly is in the first position. In this position, the digestion module is not connected to any other modules.

The digestion pump may be a binary or quaternary pump.

Trapping Module

The multidimensional LC system of the invention comprises a trapping module having a trapping column for trapping the digested sample. The trapping column is selected to have a stationary phase that retains the analytes of interest, e.g. digested antibodies, whereas any salts, buffer, detergents and other matrix components are not retained and can be washed away.

The trapping column may also serve to protect the separation column by trapping unwanted components e.g. indigested proteins in the case of protein mapping.

In some embodiments the trapping column has a length of 5 to 30 mm. In this way, the trapping column allows trapping of the sample and dilution of acetonitrile without significantly increasing the backpressure to the digestion column.

Longer column such as those used in the prior art processes (albeit not as trapping columns) are demonstrated not to allow sufficient dilution whilst maintaining reasonable back pressure. So the dilution provided by the additional trapping column is not possible in the prior art systems without potential damage to the digestion module. Additionally, the dilution provided by the trapping module of the invention means that dilution does not need to be attempted, e.g. by increasing the buffer concentration during digestion which can negatively affect the digestion stage or effect any downstream analysis such as by mass spectrometry.

In some cases the trapping column has a length of from 5 to 10 mm. In this way, sufficient trapping occurs and the back pressure can be reduced.

In some cases the trapping column has a length of from 25 to 30 mm. In this way, increased trapping occurs which is useful particularly for cases where trapping performance is very important.

In some embodiments the trapping column has a packing material with particle size of 1.0 to 3.0 μm, for example 1.0 to 2.0 μm preferably 1.5 to 2.0 μm.

In some embodiments the trapping column has an internal diameter of 1.5 to 5 mm. In some cases, the internal diameter is from 2.5 to 4.7 mm.

In some embodiments the trapping column has the same packing material as the peptide mapping column. Preferably, the trapping column has a C18 stationary phase.

In some embodiments the trapping module comprises a trapping pump and the trapping pump is fluidly connected to the trapping column when the first valve assembly is in the first position and the second valve assembly in the first position. In this position, the trapping module is not connected to any other modules.

In this way, the trapping column can be flushed after the sample is trapped on the trapping column before entering the separation column. The ability to adjust the solvent concentration on the trapping column provides the additional benefit that the solvent can be tailored to prevent removal of desired components from the trapping column.

The trapping pump may be a binary or quaternary pump.

As discussed above, in some embodiments, the digestion module has a first mixer such as a static mixer after the digestion column(s) in the direction of flow and the first mixer may be fluidly connected to the pump of the trapping module when the first valve is in the second position.

In this way, the trapping pump can provide additional solvent to the first mixer which can dilute the digested sample from the digestion column before the sample is passed onto the trapping column. Diluting the digested sample before it flows onto the trapping column can allow greater retention of the analytes of interest on the trapping column as the solvent can be chosen to ensure maximum retention.

Separation Module

The multidimensional LC system comprises a separation module having a separation column for separating analytes in the sample after release of the sample from the trapping column.

In some embodiments the separation module comprises a separation pump and the separation pump is fluidly connected to the separation column when the second valve assembly is in the first position and the second position. When the second valve is in the first position, the separation module is not connected to any other modules.

The separation pump may be a binary or quaternary pump.

In some embodiments the separation column is selected from a peptide mapping column such a UHPLC column or a HPLC column, a hydrophilic interaction chromatography column, preferably, the separation column is a UHPLC column. Preferably, the separation column is a UHPLC column.

In some cases, the separation column has a C18 stationary phase. C18 stationary phases are typically used for chromatographic separation of peptides. In this way, good peptide retention and separation can be achieved.

In some cases, the separation column has a length of 100 to 200 mm, such as around 150 mm.

In some cases, the separation column has a packing material with particle size of 1.0 to 3.0 μm, for example, 1.0 to 2.0 μm, preferably 1.5 to 2.0 μm.

In some cases, the separation column has an internal diameter of 1.5 to 5 mm, preferably 1.5 to 2.5 mm such as around 2.1 mm.

In some cases, the separation column contains a C18 stationary phase.

Reduction Module

In some embodiments, the multidimensional LC system further comprises a reduction module having a reduction column. The reduction module and the digestion module are fluidly connected when the digestion module and the trapping module are fluidly connected for example, the reduction module and the digestion module are fluidly connected when the first valve assembly is in the second position.

The sample is introduced on the reduction column and reduced for example by passing a solution of reducing agent through the reduction column after to reduce the sample on the column.

In this way, the sample to be analyzed can be reduced online before passing onto the digestion module.

In some embodiment, the reduction column contains a C3 or C4 stationary phase, preferably a C4 stationary phase. In this way, the column provides a balance between retention and elution. Suitable commercially available columns for the reduction column include the Waters ACQUITY UHPLC Protein BEH C4 VanGuard Pre-column, 300A, 1.7 μm, 2.1 mm×5 mm, 10K-500K

In some embodiments the reduction module comprises a reduction pump and the reduction pump is fluidly connected to the reduction column. In embodiments having a multiple heart cutting valve, the multiple heart cutting valve may be between the reduction pump and the reduction column in the direction of flow. The reduction pump may be a binary or quaternary pump. Preferably, the reduction pump of the reduction module is a quaternary pump.

Fractionation Module

In some embodiments, the multidimensional LC system further comprises a fractionation module having a fractionation column. The fractionation column is chromatography column for separating components in the sample to be analyzed.

In this way, the system of the invention can separate an initial sample into fractions each of which can then be further processed in the other modules.

In some embodiments, the fractionation column is selected from an ion exchange chromatography column such as a cation exchange chromatography column, size exclusion chromatography column, a hydrophilic interaction chromatography column (HILIC), a hydrophobic interaction chromatography column (HIC) or a proteinA affinity column.

In some embodiments, the multidimensional LC system further comprises a multiple heart cutting valve.

The multiple heart cutting valve may be fluidly connected to the fractionation column. The term “multiple heart cutting valve” refers to a valve assembly that allows for the online fractionation and in loop storage of fractions in a liquid chromatography system. Examples of multi heart cutting valves include a 2 position 4 port duo valve from Agilent technologies (product no. G4236A) which may be couple with one or two loop decks such as a 6 position 14 port valve loop deck from Agilent technologies (product no. G4242A).

The multiple heart cutting valve may be after the fractionation column in the direction of flow. In some such embodiments, the multidimensional LC system also has a reduction module and the multiple heart cutting valve is also fluidly connected to the reduction module and the multiple heart cutting valve is before the reduction module in the direction of flow.

In some embodiments the fractionation module comprises a fractionation pump and the fractionation pump is fluidly connected to the fractionation column. The fractionation pump may be a binary or quaternary pump.

Other

Other aspects and embodiments of the invention provide the aspects and embodiments described above with the term “comprising” replaced by the term “consisting of” and the aspects and embodiments described above with the term “comprising” replaced by the term “consisting essentially of”.

It is to be understood that the application discloses all combinations of any of the above aspects and embodiments described above with each other, unless the context demands otherwise. Similarly, the application discloses all combinations of the preferred and/or optional features either singly or together with any of the other aspects, unless the context demands otherwise.

Modifications of the above embodiments, further embodiments and modifications thereof will be apparent to the skilled person on reading this disclosure, and as such, these are within the scope of the present invention.

All documents and sequence database entries mentioned in this specification are incorporated herein by reference in their entirety for all purposes.

“and/or” where used herein is to be taken as specific disclosure of each of the two specified features or components with or without the other. For example, “A and/or B” is to be taken as specific disclosure of each of (i) A, (ii) B and (iii) A and B, just as if each is set out individually herein.

Process

The present invention also provides a multidimensional LC process for analyzing a sample of therapeutic antibodies.

The process is carried out using a system of the invention. The terminology provided for the system above is used below to define the process. Optional and preferred features of the system may be implemented in the process of the invention. For example, the preferred trapping column features of length, internal diameter or particle size disclosed above are also preferred for use in the process of the invention.

The process of the invention involves the steps of:
providing a sample of antibodies to be analyzed,
introducing the sample to a digestion module having a digestion column containing an immobilized proteolytic enzyme, such that the enzyme proteolytically cleaves the antibodies in the sample to produce a digested sample,
introducing the digested sample to a trapping column for holding the digested sample,
releasing the digested sample from the trapping column and introducing the sample to a separation module having a separation column for separating analytes in the sample,

The sample is flowed through the digestion module, trapping module and separation module using solvent and one or more pumps.

In the process a first valve assembly and a second valve assembly are used to:
provide fluid connection between the digestion module and the trapping module when the sample is digested and trapped on the trapping column; and
provide fluid connected between the trapping column and separation column when the digested sample is released from the trapping column and introduced onto the separation column; and
prevent fluid connection between the separation column and digestion column.

In some embodiment, the first valve assembly and the second valve assembly each have a first and a second position. When the sample is digested and introduced onto the trapping column the first valve assembly is in the second position and the second valve assembly in the first position. When the sample is released from the trapping column and introduced onto the separation column the second valve assembly is in the second position.

In this way, the combination of two valves can be used to effectively un-couple the separation column and the digestion column.

In some embodiments, when the sample is trapped on the trapping column after digestion, the first valve assembly is moved into the first position and a trapping pump of the trapping module flushes solvent through the trapping column before the second valve assembly is moved to the second position.

In this way, the sample trapped on the trapping column and unwanted by-products (e.g. salts) from the digestion step can be removed before further processing the sample on the separating column. This can improve separation and prevent damage to the separation column.

In some cases, the process of the invention comprises the following steps in order:
1. The first valve assembly is in the first position and the second valve assembly is in the first position at the start of the process;
2. Optionally, the sample to be analyzed is reduced on a reduction column;
3. The first valve assembly is switched to the second position and the (reduced) sample, e.g. antibodies, is flowed through the second mixer (optionally), the digestion column, the first mixer (optionally) and onto the trapping column
4. The first valve assembly is switched back to position 1 and the trapping column is washed to blush out buffer salts
5. The second valve assembly is switched to position 2 and the sample is flowed off the trapping column and through the separation column
6. Optionally, the sample is flowed off the separation column into an analysis module, such as a mass spectrometer.

In some embodiments, the trapping pump of the trapping module is used to adjust the solvent whilst the sample is trapped on the trapping column, for example when the solvent is a water acetonitrile mixture, the acetonitrile concentration is adjusted to from 1 to 5 wt %. Preferably, the digestion module has a first mixer that is after the digestion column in the direction of flow. The trapping pump is fluidly connected to the first mixer when the first valve assembly is in the second position. In this position, the trapping pump can pump solvent into the first mixer to adjust the solvent of the sample before it is loaded onto the trapping column.

In some such embodiments, the trapping pump provides a flow rate of from 0.20 to 2.5 mL/min.

This step can be used to change the solvent or liquid carrier (i.e. the mobile phase) to a preferred composition for use in the separation column. For example, in some cases, acetonitrile concentration from the digestion step is higher than preferred for the separation step. This concentration can be reduced using the isolated trapping module before passing the sample onto the separation module. This can improve the outcome of separation e.g. peptide mapping.

Preferably, the solvent used to pass the sample through the separation column is water with acetonitrile, preferably the acetonitrile concentration is from 1 to 5 wt %.

In some embodiments, the trapping column has a column temperature of from 20 to 70° C., preferably from 30 to 50° C.

In some embodiments, the trapping column and the separation column are at the same temperature such as from 30 to 50° C. when the digested sample is released from the trapping column and introduced onto the separation column. In this way, the separation of the sample can be optimized.

In some cases, the temperature of the trapping column will be changed between trapping of the digested sample and release of the digested sample. For example, trapping of the digested sample may be carried out at a lower temperature than release of the trapped sample. In this way trapping can be optimized without impacting significantly on separation. Preferably, during trapping the trapping column has a temperature of around 30° C.

In some embodiments, the process further comprises a reduction step prior to the digestion step. In some such cases, the reduction step is carried out by introducing the sample into a reduction module comprising a reduction column and reducing the sample by flowing a solvent containing a reduction agent through the reduction column whilst the sample is on the reduction column. Preferably, the reducing agent is Tris-(2-carboxyethyl)-phosphin or dithiothreitol (DTT).

In some embodiments, the process further comprises a fractionation step prior to the digestion step and, if present, prior to the reduction step.

In some embodiments, the fractionation module contains a fractionation pump. The fractionation pump may pump solvent through the fractionation column to the multi heart cutting valve when present.

In some embodiments, the reduction module contains a reduction pump. The reduction pump may pump solvent comprising a reducing agent such as Tris-(2-carboxyethyl)-phosphin or Dithiothreitol through the reduction column to reduce a sample on the reduction column.

In some embodiments, the digestion module contains a digestion pump. The digestion pump may pump solvent containing the digestion buffer onto the digestion column.

In some embodiments, the trapping module contains a trapping pump. The trapping pump may pump solvent through the trapping column. When the first valve assembly is in the second position and the digestion module contains a first mixer, the trapping pump may pump solvent through the first mixer to dilute the solvent mixture that comes off the digestion column.

In some embodiments, the separation module contains a separation pump. The separation pump may pump solvent through the separation column. When the second valve assembly is in the second position, the separation pump pumps solvent through the trapping column and then through the separation column.

In some embodiments, the process further comprises the step of analyzing the fractions of the sample as they flow off the separation column by mass spectrometry.

### Examples

In this application, a novel multidimensional LC system is provided that achieves increased sequence coverage and retention of small polar peptides compared to prior art methods.

The usage of long sub-2-micron UHPLC columns for peptide mapping analysis is facilitated by use of the inventive LC system of the invention (referred to as “mD-UHPLC-MS/MS” below) and allows a system pressure up to 1300 bar. Furthermore, the system of the invention supports a versatile digestion setup with either a single column (LysC/Trypsin) or an in-parallel LysC and Trypsin column setup.

Materials and Methods

The system of the invention used in these examples is a multidimensional LC System coupled to a mass spectrometer and operating a UHPLC separating column. The system (sometimes referred to as “mD-UHPLC-MS/MS”) is based on LC-modules from Agilent Technologies (Waldbronn, Germany) coupled with the high-resolution mass spectrometer Impact II from Bruker Daltonics.

Reagents for the analysis with the mD-UHPLC-MS/MS instrument are listed below under ‘Reagents”.

The system is configured as two instruments within the OpenLab software package from Agilent Technologies. For communication between the two instruments a self-designed macro “valve event plugin” from ANGI (Gesellschaft für angewandte Informatik, Karlsruhe, Germany) was used. The macro starts the method of the second instrument and the mass spectrometer via a contact closure signal for each fraction in the first dimension.

An overview of each “dimension” (or module) in the system is provided directly below. Following the overview, details of the instrument set up and operating parameters used in each module in each of the examples is also provided.

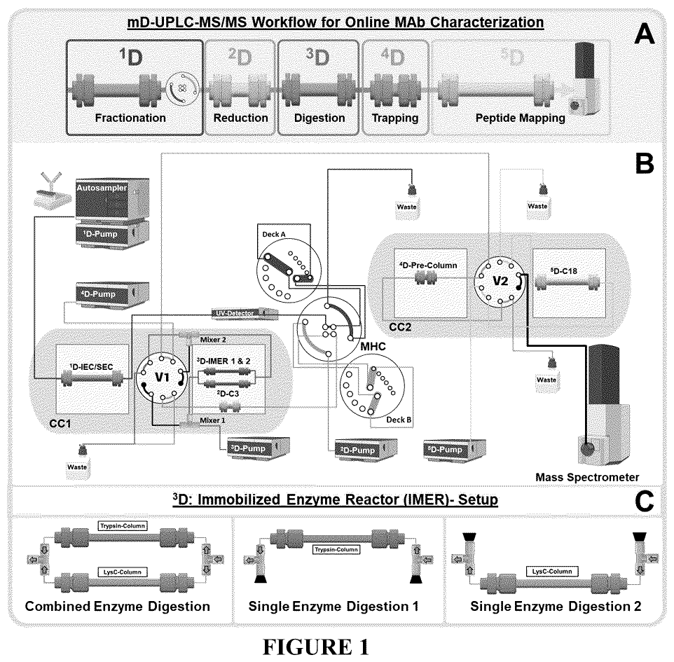

The results are discussed below in the “Results and Discussion” section and shown in Tables 1 to 4 in the “Tables” section and FIGS. 1 to 4.

¹D Fractionation Module—Ion Exchange Chromatography and Fractionation

The 1D method varies according on the product being analyzed and corresponds to the GxP-method for IEC or SEC quality control (QC) analysis. For the characterization of Herceptin® (Trastuzumab) charge variants, a MAbPac™ WCX (4.0×250 mm, 10.0 μm) column from Thermo Fisher Scientific™ was employed as first dimension. Unstressed Herceptin® (150 μg) was injected into the system and the parameters of supplementary table S3 were chosen for the cation exchange chromatography (CEX). By detecting the absorbance at 214 nm the acidic, main and basic peaks where fractionated with the MHC valve and stored in 120 μL loops of deck A and B. For reduction (2D), digestion (3D), trapping (4D) and peptide mapping analysis (5D) the fractions where subsequently processed with the following dimensions.

²D Reduction Module—On-Column Reduction

The second dimension of the mD-UHPLC-MS/MS instrument incorporates a Poroshell 300SB-C3 (2.1×12.5 mm, 5.0 μm) cartridge from Agilent Technologies for trapping and reduction of the 1D fractions. The fast on-column reduction was performed by flushing the trapped mAbs with 20 mM Tris-(2-carboxyethyl)-phosphin (TCEP). Afterwards, the C3-Cartridge was washed and the reduced mAbs were eluted onto the immobilized enzyme reactor (IMER).

³D Digestion Module—On-Column Digestion

For online digestion of the reduced 1D fractions, a custom made LysC (2.1×100 mm, Perfinity Biosciences) and/or Trypsin (2.1×100 mm, Perfinity Biosciences) IMER was used as third dimension. Thus, either an in-parallel or single enzymatic digestion setup can be selected with the mD-UHPLC-MS/MS instrument. For the parallel setup the flow is split in half in front of the columns and merged afterwards by two T-pieces. This allows a separated digestion with both columns and afterwards the combined analysis of LysC and Trypsin peptides. In addition, the mD-UHPLC-MS/MS system allows a single enzymatic digestion setup where only one column is installed and the remaining ports of the T-pieces are blocked by stop plugs. For optimal digestion, the reduced 1D fractions are diluted with digestion buffer at a ratio of 1:6 with a biocompatible 100 μL binary mixer from ASI-Analytical Scientific Instruments. During the digestion step the IMER was connected in-line with the peptide trapping column and the flow-through digestion took approximately 70 seconds.

⁴D Trapping Module—Pre-Column Trapping

After digestion the eluting peptides were diluted with Milli-Q H2O at a ratio of 1:5.5 using a biocompatible 150 μL binary mixer from ASI—Analytical Scientific Instruments. The two dilution steps (3D, 4D) result in a final acetonitrile concentration of min. 1% for peptide trapping depending on the used pre column. For the Herceptin® analysis an InfinityLab Poroshell 120 SB-C18 (3.0×5 mm, 1.9 μm) pre-column from Agilent Technologies was used. For the bispecific mAb (BsMAb) analysis an ACQUITY UHPLC BEH C18 VanGuard pre-column (2.1×5 mm, 1.7 μm) from Waters Corporation was incorporated into the system. After peptide trapping the pre-column was washed and subsequently placed in-line with the analytical full length UHPLC-column for peptide mapping analysis.

⁵D Separation Module—Peptide Mapping Analysis

The peptide mapping analysis was initiated by switching the pre-column in-line with the analytical reversed phase column. The used analytical column depends on the antibody to be investigated. For the Herceptin® analysis an InfinityLab Poroshell 120 SB-C18 (2.1×150 mm, 1.9 μm) column from Agilent Technologies was used. The chromatographic peptide separation for the BsMAb is performed by using an UHPLC BEH Peptide C18 column (2.1 mm×150 mm, 1.7 μm) from Waters Corporation. The parameters and gradients are given in supplementary table S7. For detection of MS1 and MS2 spectra, the high-resolution ESI-Q-ToF mass spectrometer Impact II from Bruker Daltonics was used.

Reagents

The following reagents were using in the examples:

| Reagent | Manufacturer | CAS No. |
|---|---|---|
| Sodium dihydrogen phosphate monohydrate | MERCK KGaA, Darmstadt, | 10049-21-S |
| | Germany | |
| di-Sodium hydrogen phosphate | MERCK KGaA, Darmstadt, | 7558-79-4 |
| | Germany | |
| Calcium chloride anhydrous Powder | MERCK KGaA, Darmstadt, | 10043-52-4 |
| | Germany | |
| Tris(hydroxymethyl) aminomethane (TRIS) | MERCK KGaA, Darmstadt, | 77-86-1 |
| | Germany | |
| Tris(2-carhoxyethyl)phosphin (TCEP) | MERCK KGaA, Darmstadt, | 51805-45-9 |
| | Germany | |
| Acetontrile (ACN, HPLC-grade) | MERCK KGaA, Darmstadt, | 75-05-8 |
| | Germany | |
| Sodium chloride | Fluka Missouri, USA | 7647-14-S |
| Formic acid (FA) | Fluka Missouri, USA | 64-18-6 |
| N,N-Bis(2-hydroxyethyl)-2-aminoethanesulfonic | MERCK KGaA, Darmstadt, | 10191-18-1 |
| acid (BES) | Germany | |
| N,N-Bis(2-hydroxyethyl)-2-aminoethanesulfonic | MERCK KGaA, Darmstadt, | 66992-27-6 |
| acid sodium salt (BES sodium salt) | Germany | |

| | |
|---|---|
| Purified Water (Milli-QH2O) | Merck Millipore (Merck KGaA, |
| | Darmstadt, Germany) Milli- |
| | QAdvantage A10 system |

Instrument Set Up

The mD-UHPLC-MS/MS system of the invention used in the examples is configured as two instruments within the OpenLab software package (ChemStation). The communication between the two instruments was performed by a custom made macro valve event plugin from ANGI (Gesellschaft fur angewandte Informatik, Karlsruhe, Germany).

| | | |
|---|---|---|
| Module | Product | Product No. |

Instrument 1 (′D/⁵D)

| | | |
|---|---|---|
| Autosampler | 1260 HiP Bio ALS | G5667A |
| Fractionation (′D-)Pump | 1290 binary pump | G4220A |
| ′D-Pump | 1290 binary pump | G4220A |
| Multiple Heart Cutting Valve | 2-position/4-port duo-valve | G4236A (MHC-kit) |
| (MHC) | | 5067-4214 (valve) |
| Loop Deck A with 6 sampling | 6-position/14-port valve | G4242A (MHC upgrade kit) |
| loops (120 id, Volume) | | 5067-4142 (valve) |
| Loop Deck B with 6 sampling | 6-position/14-port valve | G4242A |
| loops (120 itL Volume) | | 5067-4142 (valve) |
| UV detector 1 | 1260 VWD | G1314F |

Instrument 2 (²D/³D/⁴D)

| | | |
|---|---|---|
| Reduction (²D-)Pump | 1290 binary pump | G4220A |
| Digestion (³D-)Pump | 1260 quaternary pump | G1311B |
| Trapping (⁴D-)Pump | 1260 quaternary pump | G1311B |
| Column compartment 1 (CC1) | 1290 TCC | G1316C (CC1) |
| installed 2-position/10-port | | 5067-4283 (valve) |
| valve (800 bar) | | |
| Column compartment 2 (CC2) | 1290 MCT | G1314F (CC2) |
| installed 2-position/10-port | | 5067-4240 (valve) |
| valve (1300 bar) | | |

Fractionation Module—‘D Cation-Exchange Chromatography Gradient and Parameters

Ion exchange chromatography was used I the fractionation module in the system of the examples. Product specific ‘D CEX parameters and gradients are listed for Herceptin (trastuzumab) and the bi-specific mAb (BsMAb). For the Herceptin CEX a Thermo Scientific ProPac” WCX-10 Analytical, 4×250 mm column was used at 25° C. The absorbance was measured with the VWR detector at 214 nm. The BsMAb CEX was performed with a YMC BioPro IEX-SF, 100×4.6 mm, 5 μm column at 40° C. and the absorbance was measured at 280 nm.

The following parameters and timings were used in the fractionation:

Fractionation Module set up-¹D-Pump Cation Exchange
Chromatography Herceptin (trastuzumab)

| | | | Eluent B | |
|---|---|---|---|---|
| | | Eluent A | [%] | |
| | | [%] | (10 m/V1 sodium | |
| | | (10 inIVI sodium | phosphate, | |
| Time | Flowrate | phosphate, | 100 inIVI | |
| [min] | [mL/min] | pH 7.5) | NaC1 pH 7.5) | Comment |
| 0.00 | 0.8 | | 15 | CEX and peak |
| 30.00 | | | 55 | fractionation by |
| 35.00 | | | 55 | multiple heart |
| | | | | cutting |
| 36.00 | | | 10 | Wash to reduce |
| | | | 0 | carryover |
| 44.00 | | | 10 | |
| | | | 0 | |
| 45.00 | | | 15 | Column |
| 55.00 | | | 15 | equilibration |

Fractionation Module Set Up -′D-Pump Cation Exchange
Chromatography BsMAb

| | | | Eluent B | |
|---|---|---|---|---|
| | | Eluent A | [%] | |
| | | [%] | (20 in/14 BES, | |
| Time | Flowrate | (20 mM BES, | 500 inIYI NaCt | |
| [min] | [mL/min] | pH 6.8) | pH 6.8) | Comment |
| 0.00 | 0.8 | | 2 | CEX and peak |
| 5.00 | | | 2 | fractionation by |
| 35.00 | | | 15 | multiple heart |
| | | | | cutting |
| 35.10 | | | 10 | Wash to reduce |
| | | | 0 | carryover |
| 40.00 | | | 10 | |
| | | | 0 | |
| 40.10 | | | 2 | Column |
| 50.00 | | | 2 | equilibration |

S 5

Reduction Module—²D Online Reduction Gradient and Parameters

The reduction was performed on a Poroshell 3005B-C3 2.1×12.5 mm, S.0 μm (Agilent Technologies) cartridge at 40° C. The following parameters and timings were used in the reduction:

Reduction - ²D-Pump On-Column Reduction

| | | Fluent AI | Fluent B1 | | | |
|---|---|---|---|---|---|---|
| | Flow | [%] | [%] | Fluent A2 | Fluent B2 | |
| | rate | (20 mNITCEP, | (0.1% FA, | [%] | [%] | |
| Time | [mL/ | 5% ACN in | 5% ACN in | (0.1% FA in | (0.1% FA in | |
| [min] | min] | H2O) | H2O) | H2O) | ACN) | Comment |
| 0.00 | 0.50 | 0 | 100 | | | Start instrument 2 |
| | | | | | | (²D/³D/⁴D) |
| 0.01 | | 100 | 0 | | | ²D column trapping |
| | | | | | | and on-column |
| 4.00 | | 100 | 0 | | | reduction |
| 4.01 | 2.00 | | | 85 | 15 | Solvent selection |
| | | | | | | valve switch |
| 7.00 | | | | 85 | 15 | AI/B1 4 A2/B2 and |
| | | | | | | wash |
| 7.01 | 0.05 | | | 50 | 50 | Valve 1 switch 4 |
| | | | | | | 4 |
| 7.25 | | | | 50 | 50 | Elution of reduced |
| 8.00 | | | | 50 | 50 | mAbs |
| 8.01 | | | | 100 | 0 | |
| 8.50 | | | | 100 | 0 | |
| 8.51 | | | | 50 | 50 | |
| 11.50 | | | | 50 | 50 | |
| 11.51 | | | | 100 | 0 | |
| 12.00 | | | | 100 | 0 | |
| 12.01 | | | | 50 | 50 | |
| 15.00 | | | | 50 | 50 | |
| 15.01 | | | | 100 | 0 | |
| 15.50 | | | | 100 | 0 | |
| 15.51 | | | | 50 | 50 | |
| 18.50 | | | | 50 | 50 | |
| 18.51 | | | | 100 | 0 | |
| 19.00 | | | | 100 | 0 | |
| 19.01 | | | | 50 | 50 | |
| 22.00 | | | | 50 | 50 | |
| 22.01 | | | | 50 | 50 | Valve 1 switch 4 |
| | | | | | | waste |
| 23.00 | 1′00 | | | 5 | 95 | Wash to reduce |
| 23.01 | | | | 95 | 5 | carryover |
| 24.00 | | | | 5 | 95 | |
| 24.01 | | | | 95 | 5 | |
| 25.00 | | | | 5 | 95 | |
| 25.01 | | | | 95 | 5 | |
| 26.00 | | | | 5 | 95 | |
| 26.01 | | | | 95 | 5 | |
| 27.00 | | | | 5 | 95 | |
| 27.01 | | | | 95 | 5 | |
| 28.00 | | | | 5 | 95 | |
| 28.01 | | | | 95 | 5 | |
| 29.00 | | | | 5 | 95 | |
| 29.01 | | | | 95 | 5 | |
| 30.00 | | | | 5 | 95 | |
| 35.00 | | | | 5 | 95 | |
| 35.01 | 0.5 | 50 | 50 | | | Solvent selection |
| 40.00 | | 50 | 50 | | | valve switch |
| 40.01 | | 0 | 100 | | | A2/B2 4 Ai/si |
| 60.00 | | 0 | 100 | | | Column equilibration |

Digestion Module—³D Online Digestion Gradient and Parameters

For the online digestion a custom made LysC (2.1×100 mm, Perfinity Biosciences) and/or a trypsin (2.1×100 mm, Perfinity Biosciences) immobilized enzyme reactor (IMER) was used at 40° C.

The following parameters and timings were used in the digestion:

³D-Pump On-Column Digestion

| | | Eluent A | | |
|---|---|---|---|---|
| | | [%] | | |
| | | (SO mM MS, | Eluent B | |
| Time | Flowrate | 10 m/VI Ca02, | [%] | |
| [min] | [mL/min] | pH 8.5) | (ACN) | Comment |
| 0.00 | 0.25 | 100 | 0 | Start instrument 2 |
| | | | | (²D/³D/⁴D) |
| 0.01 | 1.50 | 50 | 50 | Wash to reduce |
| 4.00 | | 50 | 50 | carryover |
| 4.01 | | 100 | 0 | |
| 6.00 | | 100 | 0 | |
| 6.01 | 0.25 | 100 | 0 | |
| 7.01 | | 100 | 0 | Valve 1 switch 4 |
| | | | | 4 |
| 7.02 | | 100 | 0 | Digestion of reduced |
| 22.00 | | 100 | 0 | mAbs |
| 22.01 | | 100 | 0 | Valve 1 switch 4 |
| | | | | 4 |
| 25.00 | | 100 | 0 | Wash to reduce |
| 25.01 | 1 50 | 50 | 50 | carryover |
| 30.00 | | SO | 50 | |
| 30.01 | | 100 | 0 | |
| 31.00 | | 100 | 0 | |
| 31.01 | | 50 | 50 | |
| 32.00 | | 50 | 50 | |
| 32.01 | | 100 | 0 | |
| 33.00 | | 100 | 0 | |
| 33.01 | | 50 | 50 | |
| 34.00 | | 50 | 50 | |
| 34.01 | | 100 | 0 | |
| 35.00 | 0.25 | 100 | 0 | Column equilibration |

Trapping Module—⁴D Peptide Trapping Gradient and Parameters

In the examples, peptide trapping was performed on a trapping (pre)column, which matched with the main separation column. For Herceptin an InfinityLab Poroshell 120 SB-C18 3.0× S mm, 1.9 vm (Agilent Technologies) precolumn was used at 30° C. For the BsMAb analysis an ACQUITY UHPLC BEH C18 2.1× Smm, 1.7 μm (Waters Corporation) precolumn was used at 30° C. and switched to 45° C. one minute prior peptide mapping analysis (24 min.

The following parameters and timings were used in the trapping:

Trapping (⁴D-)Pump Peptide Trapping

| | | Eluent A | Eluent B | | | |
|---|---|---|---|---|---|---|
| | | [%] | [%] | Eluent C | Eluent D | |
| Time | Flowrate | (0.1% FA | (0.1% FA | [%] | [%] | |
| [min] | [mL/min] | in H2O) | in ACN) | (H2O) | (ACN) | Comment |
| 0.00 | 0.25 | 95 | 5 | 0 | 0 | Start instrument 2 |
| | | | | | | (²D/³D/⁴D) |
| 0.01 | 1.00 | 95 | 5 | 0 | 0 | Wash to reduce |
| 1.00 | | 5 | 95 | 0 | 0 | carryover |
| 2.00 | | 5 | 95 | 0 | 0 | |
| 2.01 | | 95 | 5 | 0 | 0 | |
| 3.00 | | 5 | 95 | 0 | 0 | |
| 4.00 | | 5 | 9S | 0 | 0 | |
| 4.01 | | 99 | 1 | 0 | 0 | |
| 5.00 | | 0 | 0 | 100 | 0 | |
| 7.01 | 1.35-2.20 | 0 | 0 | 100 | 0 | Valve 1 4 4 |
| 7.02 | (depending | 0 | 0 | 100 | 0 | ⁴D column trapping |
| 22.00 | on precolumn) | 0 | 0 | 100 | 0 | |
| 22.01 | | 0 | 0 | 99 | 1 | Valve 1 switch ⁴D 4 |
| | | | | | | waste |
| 22.02 | | 0 | 0 | 99 | 1 | Wash to reduce |
| 25.00 | | 0 | 0 | 99 | 1 | salt concentration |
| 25.01 | 0.10 | 95 | 5 | 0 | 0 | Valve 2 switch |
| | | | | | | 4 ⁵D 4 MS |
| 59.00 | | 95 | 5 | 0 | 0 | Valve 2 switch |
| | | | | | | 4 waste |
| 59.01 | 0.25 | 95 | 5 | 0 | 0 | Column |
| | | | | | | equilibration |

Separation Module—Peptide Mapping Gradient and Parameters

The peptide mapping analysis was performed on an UHPLC-column, depending on the analyzed mAb. For Herceptin an InfinityLab Poroshell 120 SB-C18 2.1×150 mm, 1.9 vm (Agilent Technologies) UHPLC-column was used at 40° C. For the BsMAb analysis an Waters ACQUITY UPLC Peptide BEH 018 Column, 300A, 1.7 yin, 2.1 mm×150 mm (Waters Corporation) UPLC-column was used at 40° C. For both columns a flowrate of 0.4 mL/min was used.

The following parameters and timings were used in the peptide mapping:

Separation (⁵D-)Pump Peptide Mapping Analysis

| Time | Fluent A [%] | Fluent B [%] | |
|---|---|---|---|
| [min] | (0.1% FA in H20) | (0.1% FA in ACN) | Comment |
| 0.00 | 95 | 5 | Start instrument 2 (²D/³D/⁴D) |
| 0.01 | 95 | 5 | Wash to reduce carryover |
| 2.00 | 5 | 95 | |
| 3.00 | 5 | 95 | |
| 3.01 | 95 | 5 | |
| 5.00 | 5 | 95 | |
| 6.00 | 5 | 95 | |
| 6.01 | 95 | 5 | |
| 8.00 | 5 | 95 | |
| 9.00 | 5 | 95 | |
| 9.01 | 95 | 5 | |
| 11.00 | 5 | 95 | |
| 12.00 | 5 | 95 | |
| 15.00 | 99 | 1 | |
| 25.01 | 99 | 1 | Valve 2 switch 4 ′D 4 MS |
| 65.00 | 60 | 40 | Peptide mapping analysis |
| 68.00 | 40 | 60 | |
| 69.00 | 5 | 95 | |
| 70.00 | 5 | 95 | |
| 70.01 | 95 | 5 | Wash to reduce carryover |
| 71.00 | 5 | 95 | |
| 72.00 | 5 | 95 | |
| 72.01 | 95 | 5 | |
| 73.00 | 5 | 95 | |
| 74.00 | 5 | 95 | |
| 74.01 | 95 | 5 | Valve 2 switch 4 waste ⁵D 4 |
| | | | waste |
| 75.00 | 95 | 5 | Column equilibration |

Analysis Module—Parameters of the mD-UHPLC-MS/MS Mass Spectrometer

Parameters of the Impact II high resolution mass spectrometer from Bruker Daltonics which was coupled to the mD-UHPLC system of the invention used in the examples were as follows:

Mass Spectrometer Parameters

| Spray voltage | 4.5 | kV |
|---|---|---|
| End plate offset | 500 | V |
| Nebulizer | 2.0 | bar |
| Dry gas flow | 11.0 | L/min |
| Dry temperature | 220° | C. |
| MS mode | positive | |
| Scan range | 150-2000 | m/z |
| Spectra rate | 2.00 | Hz |

| | |
|---|---|
| Fragmentation | Collision -induced dissociation (CID) |
| MSMS | Auto, cycle time 3.0 sec |

Results and Discussion

Setup Differences mD-UHPLC-MS/MS of the Invention Vs. 4D-HPLC/MS of the Prior Art

The schematic setup of the system of the invention (mD-UHPLC-MS/MS system) is shown in FIG. 1. The system has major improvements over the system of Gstöttner One difference between the system of the invention and the system of Gstöttner is the implementation of an additional dimension, 4D peptide dilution/trapping, in the system of the invention. The additional dimension leads to multiple advantages. The main advantages include that the usage of long UHPLC columns for peptide mapping analysis (≤1300 bar) are permitted. Additionally, a low acetonitrile concentration can be achieved during peptide trapping and this provides for increased sequence coverage during the separation, e.g. peptide mapping, step.

Despite the implementation of another dimension, the system of the invention can also be simplified compared to the system of Gstöttner et al. This can be achieved by reducing the number of valves from three (in Gstöttner et al) to two in the system of the invention. In particular, by incorporating 2-position/10-port valves instead of 2-position/6-port valves.

This provides more user friendliness and a reliable system with fewer vulnerabilities for leakage.

Additionally the system of the invention may use biocompatible static mixers for homogenous merging of the flows compared to the T-pieces of the Gstöttner system.

Furthermore, the mD-UHPLC-MS/MS system may incorporate a ²D binary pump instead of a 2D quaternary pump (4D-HPLC/MS). This replacement may minimizes the delay volume of the ²D pump and allows us to improve the mD-UHPLC performance by reducing the online sample preparation time.

Another new feature of the mD-UHPLC system includes a versatile LysC and Trypsin IMER-setup, thus allows in addition to the single enzymatic digestion, an in-parallel digestion. In contrast, the 4D-HPLC/MS system uses a single Trypsin IMER.

Comparison the System of the Invention and Gstöttner

Previous studies with multidimensional LC-MS instruments have shown that there are challenges, such as reduced sequence coverage compared to offline analysis due to incomplete retention of small polar peptides.

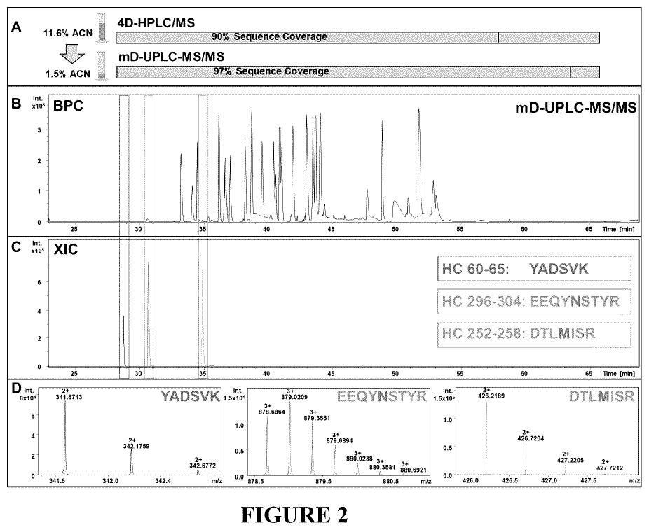

To demonstrate the improved performance of the system of the invention a comparison with the system by Gstöttner et al. (2018) was carried out. The results of the comparison are shown in FIG. 2.

Specifically, FIG. 2 shows the base peak chromatogram (BPC) of the mD-UHPLC-MS/MS instrument of the invention analyzing the main peak fraction (¹D cation-exchange chromatography, CEX) of Herceptin® (Trastuzumab).

The results show that the system of the invention provides a higher sequence coverage (97%) compared to the Gstöttner system (reported as 90% therein).

In addition, the improved setup of the invention enables the identification of the oxidized Met255 (HC, T21: DTLMISR), the CDR-H2 region (HC, T7: YADSVK), the N-glycosylated peptide (HC, T23: EEQYNSTYR) and other small peptides. These results demonstrate that the system of the invention is capable of analyzing the previously not retained peptides and provides high sequence coverage.

The detection of small peptides and the increased sequence coverage with the system of the invention may also be favored by the low acetonitrile concentration of 1.5% that can be achieved during peptide trapping using the system of the invention.

In comparison, the system by Gstöttner et al. provides a high acetonitrile concentration of approximately 11.6%, which results in unretained peptides during the trapping step. The 10-fold increased acetonitrile concentration of the Gstöttner system is a result of the in-line connection during online sample preparation of the reducing cartridge (2D), the immobilized Trypsin column (3D) and the peptide-mapping column (4D). Both, the 2D and the 4D steps in Gstöttner are reversed phase columns and a high acetonitrile concentration of 60% is necessary to elute the reduced mAb chains from the 2D column. After reduction the acetonitrile concentration is diluted to 11.6% prior the immobilized Trypsin column.

Acetonitrile Concentration

Using a system of the present invention, it is possible to achieve the low acetonitrile concentration due to the separate trapping column. In some cases, this may be provided by using trapping module with a pump and a digestion module with a first mixer, which enables an additional dilution step after the digestion step, e.g. after the Trypsin column (3D).

The results in table 1 show that small trapping columns (5 mm, table 1: *C1-*C3) provide the lowest acetonitrile concentration of 1%-1.5% during peptide trapping. With medium trapping columns (30 mm, table 1: *C4-*C5) an acetonitrile concentrations of 2.3%-4.5% is obtained. In addition, the capability of adjusting the acetonitrile concentration opens up new opportunities for chromatographic methods, such as hydrophilic interaction chromatography (HILIC), as an increase up to 99% is also possible.

The use of long C18 columns (50 mm-100 mm, table 1: *C6, *C7), which are used in the Gstöttner and other prior art systems enables only lower dilution rate to ensure moderate 3D pressure levels. This results in increased acetonitrile concentration of 6.1%-11.6% while peptide trapping. Thus, implementing a dilution step in the prior art systems cannot be used to achieve acetonitrile concentrations below 5% whilst protecting the digestion column (i.e. the IMER).

In contrast, the systems of the present invention such dilution can be achieved.

This is particularly the case when small trapping columns are used (5-30 mm) that allow adjusting the acetonitrile concentration to a minimum of 1% by modifying the 4D-pump flow rate during the trapping step itself (table 1).

The results in table 1 show, that small trapping columns (5 mm, table 1: *C1-*C3) provide the lowest acetonitrile concentration of 1%-1.5% during peptide trapping. With medium trapping columns (30 mm, table 1: *C4-*C5) an acetonitrile concentrations of 2.3%-4.5% is obtained. In addition, the capability of adjusting the acetonitrile concentration opens up new opportunities for chromatographic methods, such as hydrophilic interaction chromatography (HILIC), as an increase up to 99% is also possible.

Goyon and coworkers (2020) took a different approach with their 4D-LC system to reduce the acetonitrile concentration. Instead of an additional dilution they decreased the 2D-pump flow rate to 0.025 mL/min (4D-LC-MS by Gstöttner et al. (2018)=0.06 mL/min¹⁴) and used a gradient to elute the reduced mAb chains. This resulted in a final acetonitrile concentration of <6.5% while peptide trapping, which increased the obtained sequence coverage¹⁶. With this setup Goyon et al. (2020) were able to generate reproducible results and detect small polar peptides. Nevertheless, it has to be considered that compared to the mD-UHPLC-MS/MS system their method is limited to an acetonitrile concentration around 6.5%, which could already lead to a loss of hydrophilic peptides. A lower acetonitrile concentration can be beneficial for the characterization of those peptides for example if methionine or tryptophan residues are oxidized and the trapping performance is reduced. For this issue the flexibility of the mD-UHPLC-MS/MS system and the possibility of adjusting the acetonitrile concentration down to 1% can be an advantage. Additionally, Goyon at al. (2020) showed that with an increased particle size, C18 columns with 100 mm length can be used for peptide trapping and mapping without damaging the pressure sensitive Trypsin IMER16. Recent publications adopted this approach and demonstrated that the backpressure of these columns is low enough to archive acetonitrile concentrations of approx. 5.5% through dilution^{5, 17} However, with increased particle size a lower chromatographic resolution and peak capacity is obtained compared to sub 2-micron UHPLC columns, which can be used with the mD-UHPLC-MS/MS system. In the referred publication, Pot et al. (2021) increased the digestion buffer flow rate to dilute the acetonitrile concentration and was able to characterize small polar peptides¹⁷. Compared to our new setup with an additional 4D-pump for dilution, this approach has some disadvantages. The higher digestion buffer flow rate results in a shorter digestion time on the immobilized Trypsin column, which could lead to less efficient digestion and increased miss cleavage rate.

Besides that, more salt containing digestion buffer is pumped over the analytical C18-column, which could lead to a more contaminated mass spectrometer. In contrast to recent mD-LC-MS systems, our setup leads to the complete uncoupling of the pressure sensitive IMER from the full-length analytical peptide-mapping column, which offers multiple advantages. Due to the independence from 3D pressure limits, this setup allows, to our knowledge for the first time, a completely free column choice for the peptide mapping analysis by mD-LC-MS instruments. This includes the cutting-edge technology of sub-2 micron UHPLC columns with a pressure rating up to 1300 bar for an optimal peptide separation. Thus, with the mD-UHPLC-MS/MS system the established, routine UHPLC-MS peptide mapping methods and respective UHPLC-columns can be selected for online analysis, without compromising inner diameter, length or particle size. Compared to HPLC columns, the use of UHPLC columns can improve both intensity and chromatographic separation, which is a major advantage in PTM characterization¹⁸⁻²⁰. Furthermore, the additional trapping column avoids the high pH and salt containing digestion buffer by entering the analytical full-length column, which leads to a less contaminated mass spectrometer and improved column lifetime. The more inexpensive guard column also traps undigested protein and impurities thereby protects the analytical column.

Small Polar Peptides

For retention of small polar peptides, different pre-main-column combinations were tested and evaluated according to the obtained sequence coverage of Herceptin® (Trastuzumab) (table 2).

The comparison indicates that various C18 stationary phases have different retention capabilities of small peptides and a direct impact of the achieved sequence coverage. In addition, columns with identical stationary phases but with different length and inner diameters (ID) were tested.

The results in table 2 show that the column length and ID have a less significant impact on sequence coverage, thus small trapping cartridges provide sufficient peptide retention.

In contrast, ID, particle size and length have an effect on the column backpressure. A reduction of the ID and particle size causes an increased pressure, while a shorter column results in decreased pressure.

For this reason small guard cartridges (5 mm-10 mm) with increased ID (3.0-4.6 mm) and low backpressure are preferred for peptide trapping.

Additional trapping performance of small peptides can be achieved by using 30 mm pre-columns. If a high sequence coverage is required, a low pre-column temperature (30° C.) can be set to increase the trapping performance of less retentive peptides.

However, it can be preferable that the temperature of the trapping column is higher than the separation column during separation e.g. peptide mapping analysis, otherwise the peptides cannot be refocused on the separation column. In some cases, the trapping column temperature is increased from 30° C. to 45° C. prior separation on the separation column peptide mapping analysis to match the main column and improve the chromatography.

In 2021 Camperi and coworkers (Camperi, J.; Grunert, I.; Heinrich, K.; Winter, M.; Oezipek, S.; Hoelterhoff, S.; Weindl, T.; Mayr, K.; Bulau, P.; Meier, M., Inter-laboratory Study to Evaluate the Performance of Automated Online Characterization of Antibody Charge Variants by Multi-Dimensional LC-MS/MS. Talanta 2021, 122628.) evaluated a multidimensional LC-MS workflow for the extended characterization of mAb charge variants. For comparison of th system of the invnetion with the work of Campari, the CEX profile of Herceptin® according to Campari et al was characterised.

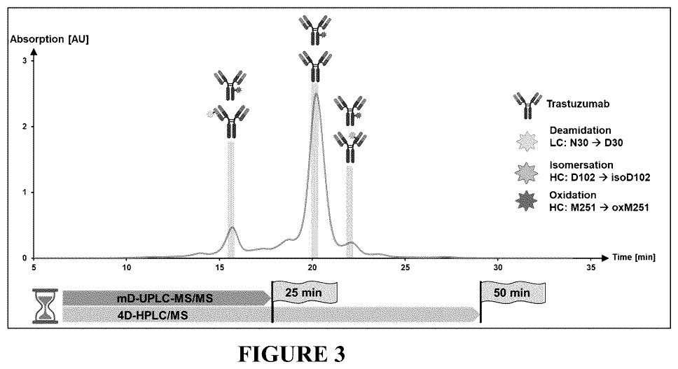

The main peak, the acidic and basic peak of Herceptin® were characterised (FIG. 3). The results in table 3 indicate that the incorporation of a trapping column in the system of the invention does not adversely affect PTM characterization. The modifications were characterized with the same accuracy and intensity as the state of the art systems such as that of Campari et al.

In the acidic peak, the deamidation of the light chain asparagine 30 was calculated 43.3±0.3% for the system of the invention (table 3). With prior art multidimensional LC-MS instruments such as Campari et al this modification was determined between 40.4±2.0% and 44.6±0.7%, which is in a comparable range.

In addition, the results of the low abundant modifications (table 3, black) using the system of the invention are also in good agreement with the results from Camperi et al. (2021).

For the isomerization of the heavy chain (HC) aspartic acid 102, the system of the present invention provides lower levels compared to the offline characterization and recent multidimensional LC-MS instruments mentioned by Camperi et al. (2021). With the system of th einvention the HC-Asp102 isomerization was calculated at 35.4±0.1% (table 3). Offline characterization show higher levels of about 45.3% (see, Schmid, I.; Bonnington, L.; Gerl, M.; Bomans, K.; Thaller, A. L.; Wagner, K.; Schlothauer, T.; Falkenstein, R.; Zimmermann, B.; Kopitz, J., Assessment of susceptible chemical modification sites of trastuzumab and endogenous human immunoglobulins at physiological conditions. Communications biology 2018, 1 (1), 1-10).

This difference could be explained by the short sample preparation time of only 25 min with the system of the invention. In contrast, the offline approach requires long sample handling (˜24 hours), which could induce method related artifacts, therefore increase the PTM levels.

The increased retention of small polar peptides with the system of the inventions meant that the oxidized methionine 255 of the heavy chain could be detected. The results show that the oxidized HC-Met255 is present in all three fractions (acidic, main, basic) of the CEX with comparable levels between 2.3±0.0% and 3.5±0.0% (table 3). This indicates that the CEX is not suitable to separate the oxidized and the corresponding unmodified Met255 species of Herceptin®.

The results in table 3 show that for the PTM quantification standard deviation values (SD) between 0.0-0.4% were obtained. This results in relative standard deviations (RSDs) of under 1% for the primary modifications in the acidic (Deam/Asn30; RSD=0.7%) and basic peaks (Iso/Asp102; RSD=0.3%). For the low abundant modifications (PTM<4%) also low SD-values in the range of 0.0-0.4% were calculated. Due to the low level of these modifications the calculated RSD values are higher and vary between 0.0-12.5%. For the PTMs with very low abundance of 50.5% higher RSD values are observed. The evaluation of these very low abundant PTMs is more error prone, due to difficulties by setting the integration limits for less intense extracted ion chromatograms (XICs). Nevertheless, the SD and RSD values are in good agreement compared to prior art mulltidimensional LC-MS systems. Especially for PTMs >0.5% the small RSD values emphasize a good precision and reproducibility for this online approach.

Sample Run Time

In comparison to prior art systems, the system of the invention may also increases the performance and the sample throughput by reducing the online sample preparation time by 50% from 50 minutes to 25 minutes (see FIG. 3).

The significantly shorter time of the system of the invention is provided by replacing the 2D quaternary pump with a modified binary pump for on-column reduction. This improvement was achieved, by the potential of our zero delay volume binary pump with a customized four-channel solvent selection valve. This configuration allows much faster gradients at very low flow rates (50 μL/min) compared to the previously used quaternary pump with a large delay volume of approximately 1 mL.

Characterization of a Bispecific Monoclonal Antibody by mD-UHPLC-MS/MS

Production is a critical phase in the life cycle of biopharmaceuticals and can lead to unintentional modifications of amino acids. Since undesired PTMs can affect product quality, safety, and efficacy, the production process must be optimized and changes to the molecule need to be monitored.

Studies have shown that sterilization of prefilled syringes with ethylene oxide (EO) can lead to methionine, cysteine and histidine EO-adducts21-22.

To assess the influence of EO during filling of a bispecific antibody (BsMAb), forced degradation studies were performed. For identification of susceptible amino acids, the samples were analyzed by the mD-UHPLC-MS system of the invention and the results were used for further process optimization.

BsMAb (provided by F. Hoffmann-La Roche LTD, Basel CH) was incubated for 7 days at 30° C. with 0.01% EO. As a negative control, the unstressed sample was incubated under the same condition without EO.

As first dimension of the mD-UHPLC-MS/MS system of the invention a cation exchange chromatography step (CEX) was performed incorporating a BioPro IEX-SF, 100×4.6 mm, 5 μm column (YMC Europe GmbH).

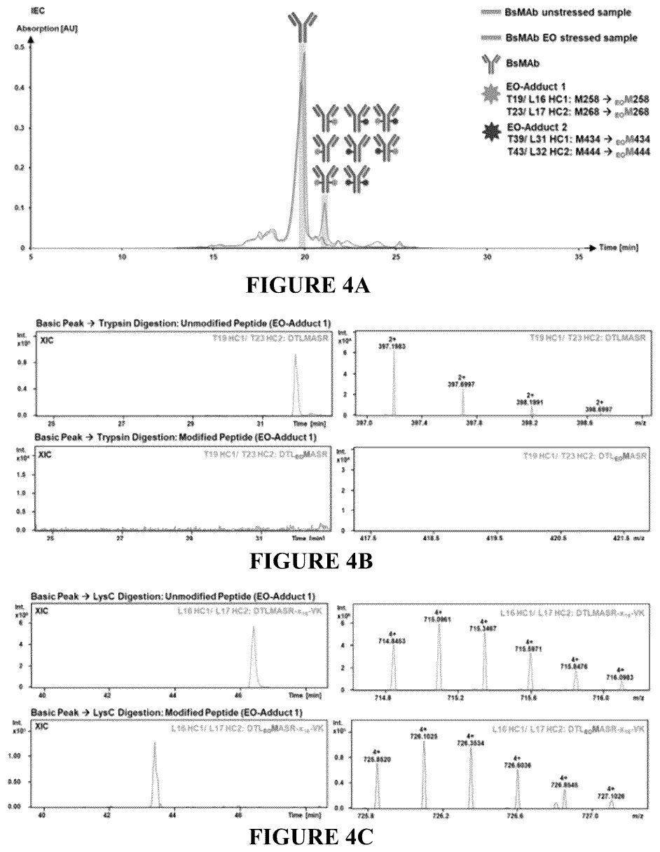

For characterization of unstressed or stressed BsMAb sample 200 μg were injected and parameters were chosen for the 1D CEX as disclosed above in the section “Fractionation Module—‘D Cation-Exchange Chromatography Gradient and Parameters”. The absorbance was detected at 280 nm and the main and basic peaks were fractionated with the MHC valve (see FIG. 4A).

Subsequently the fractions were processed with the reduction and digestion using the combined Trypsin, LysC digestion setup. The results are discussed below and shown in table 4 and FIGS. 4A-4C.

The 1D CEX chromatograms in FIG. 4A indicate that the basic peak at approx. 21 min has increased intensity in the EO-stressed sample compared to the unstressed sample. For this reason, it is considered that the EO-adducts elute at this time point. To identify the BsMAb adducts, the basic peak and as a control the main peak were fractionated and analyzed with the system of the invention described above in the Examples.

The results in FIG. 4B show that only the unmodified tryptic Peptide T19/T23 (M258 HC1/M268 HC2) were detected in the basic peak. The EO-adduct (EOM258 HC1/EOM268 HC2) of the T19/T23 peptide were not detected with the Trypsin digestion. Nevertheless, the extracted ion chromatograms (XIC) in FIG. 4C show that with the LysC digestion the unmodified peptide and in addition the corresponding EO-adduct (L16/L17) were identified.

As listed in table 4 the relative abundance of the EO-adduct 1 was 2.3±0.3% (LysC; RSD=13.0%) in the basic peak of the EO-stressed sample. The missing identification of the tryptic peptide can be attributed to the sequence of the used BsMAb and the related lack of retention.

Compared to Herceptin® the BsMAb incorporates an alanine instead of an isoleucine (DTLMISR→DTLMASR). This substitution leads to decreased hydrophobicity of the peptide. In addition, the methionine EO-adduct also leads to a more polar peptide species compared to the unmodified peptide, thus less retention on a trapping column. These circumstances further increase the difficulty of characterization with the prior art multidimensional LC-MS systems and promote the usage of a combined digestion setup.

The system of the invention can also be applied to the analysis of methionine oxidation, thus enhance the characterization by LysC digestion. Due to the additional LysC digestion, longer peptides can be generated compared to Trypsin digestion, if they end on an arginine.

In general, the enlarged peptide length by LysC digestion increases retention on the trapping column and simplifies characterization. Furthermore, the combined digestion can generate two distinct peptides for the same modified amino acid, therefore support the identification of PTMs.

The dual identification can be observed for the second EO-adduct that we found for the basic peak fraction of the EO-stressed sample.

As listed in table 4 the EO-adduct 1 was identified as Trypsin and LysC peptide, which increases the chance of a true positive identification. In addition, the relative abundance of the tryptic and LysC EO-adduct 2 were comparable with values of 3.3±0.0% (Trypsin; RSD=0.0%) and 3.7±0.1% (LysC; RSD=2.7%). The minor difference can be explained by the varying miss cleavage rate of the two IMER-columns, which can effect relative quantification. The low SD and RSD values of the triplicates for the PTM quantification shows, that the mD-UHPLC-MS/MS system provides reproducible and reliable results over multiple injections. Moreover, the combined digestion setup increased the obtained sequence coverage of BsMAb from 95% to 98%.

The combined digestion setup is beneficial if the mAb concentration of the 1D fraction is high enough. Use of long analytical C18 UHPLC columns as the separation column (length s 150 mm) for an optimal Trypsin and LysC peptide separation and less co-elution is preferred due to the increased amount of unique peptides in a parallel digestion setup compared to the single enzymatic digestion.

The study demonstrate that the system of the invention enables the identification of a very low retentive ethylene oxide modified peptides, which can occur during mAb production.

Another advantage of the parallel digestion setup is that a unique Trypsin and a LysC peptide can be received. This increases the likelihood of PTM characterization and the obtained sequence coverage. With the increasing number of more complex bispecific mAbs, in-parallel digestion can be a significant advantage for PTM characterization.

Detection of low retentive peptides and increased sequence coverage may be facilitated by an acetonitrile dilution step prior peptide trapping. Compared to recent systems the invention enables the adjustment of the acetonitrile concentration to a minimum of 1%, which is equal to the offline method.

This study further demonstrates the value of the system of the invention for the pharmaceutical industry as all 12 measurements can be accomplished in a fully automated manner in under 18 hours.

Tables

Some of the results from the Examples discussion above are provided in the following tables 1 to 4.

TABLE 1

| | ACN | Flow. | Temp. | ID | Length | P. Size |
|---|---|---|---|---|---|---|
| Column | [%] | [mL/min] | [° C.] | [mm] | [mm] | [μm] |
| *C1 | 1.0 | 2.20 | 30 | 4.6 | 5 | 2.7 |
| *C2 | 1.2 | 1.70 | 30 | 3.0 | 5 | 1.9 |
| *C3 | 1.5 | 1.35 | 30 | 2.1 | 5 | 1.7 |
| *C4 | 2.3 | 0.80 | 60 | 4.6 | 30 | 2.7 |
| *C5 | 4.5 | 0.25 | 60 | 3.0 | 30 | 1.7 |
| *C6 | 6.1 | 0.11 | 60 | 2.1 | 100 | 3.5 |
| *C7 | 8.3 | 0.00 | 60 | 2.1 | 50 | 1.7 |

*C1: Agilent InfinityLab Poroshell 120 SB-C18 Fast Guards
*C2: Agilent InfinityLab Poroshell 120 SB-C18 Fast Guards
*C3: Waters ACQUITY UPLC BEH C18 Pre-Column
*C4: Agilent InfinityLab Poroshell 120 SB-C18 Column
*C5: Waters ACQUITY UPLC Peptide BEH C18 Column
*C6: Waters XSelect Peptide CSH C18 Column
*C7: Waters ACQUITY UPLC Peptide BEH C18 Column

Table 1 above shows a pre-column pressure and dilution comparison: comparison of different pre-columns used for peptide trapping with the mD-UHPLC-MS/MS system. The pressure was measured by the 3D-pump during the analysis of the main peak fraction of Herceptin® (Trastuzumab, 50 μg injection). The mD-UHPLC-MS/MS system was operating in the single enzyme digestion mode with a Trypsin IMER installed. The listed flow rates (Flow.) represent the 40-pump flow rate for dilution excluding the 20-pump 0.05 mL/min (50% ACN) and 3D-pump 0.25 mL/min (Digestion buffer) flow rates. For each column the highest 4D-pump flow rate is listed before the 3D-pump exceeds the pressure limit of the 3D-Trypsin column (<170 bar). In addition the calculated acetonitrile concentration while peptide trapping on the 4D pre-column is listed (ACN). For the small trapping columns with a length of 5 mm the temperature was set to 30° C. for optimal trapping performance. For longer columns, the temperature (Temp.) was set to 60° C. because of the higher backpressure at low temperatures. Additionally, the inner diameter (ID), length (Length) and particle size (P. Size) are listed for each column.

TABLE 2

| | Main- | Seq. |
|---|---|---|
| Pre-column | column | Cov. |
| Agilent InfinityLab Poroshell 120 SB-C18 | *1 | 96% |
| 2.1 × 5 mm, 1.9 μm | | |
| Agilent InfinityLab Poroshell 120 SB-C18 | | 97% |
| 3.0 × 5 mm, 1.9 μm | | |
| Agilent InfinityLab Poroshell 120 SB-C18 | | 97% |
| 4.6 × 5 mm, 2.7 μm | | |
| Agilent InfinityLab Poroshell 120 SB-C18 | | 97% |
| 4.6 × 30 mm, 2.7 μm | | |
| Agilent InfinityLab Poroshell 120 EC-C18 | *2 | 93% |
| 3.0 × 5 mm, 1.9 μm | | |
| Agilent AdvanceBio Peptide Mapping | *3 | 96% |
| 2.1 × 5 mm, 2.7 μm | | |
| Agilent AdvanceBio Peptide Mapping | | 96% |
| 3.0 × 5 mm, 2.7 μm | | |
| Agilent AdvanceBio Peptide Mapping | | 96% |
| 4.6 × 5 mm, 2.7 μm | | |
| Waters Atlantis dC18 Column | *4 | 96% |
| 3.0 μm, 2.1 mm × 30 mm | | |
| Waters ACQUITY UPLC Peptide BEH C18 | | 96% |
| 1.7 μm, 2.1 mm × 5 mm | | |
| Waters ACQUITY UPLC Peptide BEH C18 | | 97% |
| 1.7 μm, 3.0 mm × 30 mm | | |
| Waters ACQUITY UPLC Peptide CSH C18 | *5 | 92% |
| 1.7 μm, 3.0 mm × 30 mm | | |

*1: Agilent InfinityLab Poroshell 120 SB-C18 2.1 × 150 mm, 1.9 μm
*2: Agilent InfinityLab Poroshell 120 EC-C18 2.1 × 150 mm, 1.9 μm
*3: Agilent AdvanceBio Peptide Mapping, 2.1 × 150 mm, 2.7 μm
*4: Waters ACQUITY UPLC Peptide BEH C18, 1.7 μm, 2.1 mm × 150 mm
*5: Waters ACQUITY UPLC Premier Peptide CSH C18, 1.7 μm, 2.1 mm × 150 mm

Table 2 above shows a column combination recommendation: Sequence coverage (Seq. Cov.) comparison of the main peak CEX fraction of Herceptin® obtained with the mD-UHPLC-MS/MS system with different pre- and main-column combinations. For the analysis 50 μg of Herceptin® were injected into the system and the single digestion setup with a Trypsin column was used. The data analysis and sequence coverage calculation was accomplished with the PMI-Byos (Byonic) software version 4.0-53 (Protein Metrics Inc.). For the peptide identification MS/MS spectra were used. The precursor mass tolerance was set to 10 ppm and a miss cleavage rate of one was permitted.

TABLE 3

| | | Rel. Abundance [%] ± SD [%] | | |
|---|---|---|---|---|
| Peptide | PTM | Acidic | Main | Basic |
| *LC-T3 | Asn30 | 43.3 ± 0.3 | 0.8 ± 0.1 | 3.4 ± 0.4 |
| (CDR-L1) | (Deam/ | | | |
| | +0.9840) | | | |
| | Asn30 | 1.4 ± 0.1 | 0.1 ± 0.0 | 0.2 ± 0.0 |
| | (Suc/ | | | |
| | −17.0265) | | | |
| *HC-T6 | Asn55 | 0.2 ± 0.0 | 0.1 ± 0.0 | 0.3 ± 0.1 |
| (CDR-H1) | (Deam/ | | | |
| | +0.9840) | | | |
| | Asn55 | 0.6 ± 0.0 | 0.5 ± 0.0 | 0.7 ± 0.0 |
| | (Suc/ | | | |
| | −17.0265) | | | |
| *HC-T12 | Asp102 | 0.0 ± 0.0 | 0.0 ± 0.0 | 35.4 ± 0.1 |
| (CDR-H3) | (Iso/ | | | |
| | 0.0000) | | | |
| | Asp102 | 1.4 ± 0.1 | 2.0 ± 0.2 | 2.6 ± 0.1 |
| | (Suc/ | | | |
| | −17.0265) | | | |
| *HC-T37 | Asn387/ | 0.3 ± 0.1 | 0.3 ± 0.0 | 0.5 ± 0.4 |
| | 392/393 | | | |
| | (Deam/ | | | |
| | +0.9840) | | | |
| | Asn387/ | 1.7 ± 0.2 | 1.4 ± 0.1 | 1.8 ± 0.2 |
| | 392/393 | | | |
| | (Suc/ | | | |
| | −17.0265) | | | |
| *HC-T21 | Met255 | 3.5 ± 0.0 | 2.3 ± 0.0 | 3.3 ± 0.1 |
| | (Ox/ | | | |
| | +15.9949) | | | |

*LC-T3: ASQDVNTAVAWYQQKPGK
*HC-T6: IYPTNGYTR
*HC-T12: WGGDGFYAMDYWGQGTLVTVSSASTK
*HC-T37: GFYPSDIAVEWESNGQPENNYK
*HC-T21: DTLMISR

Table 3 above shows PTM characterization of Herceptin® charge variants by CEX mD-UHPLC-MS/MS. Relative quantification of the PTM level from the Herceptins CEX fractions acidic, main and basic obtained by MS/MS peptide mapping analysis with the mD-UHPLC-MS/MS instrument. The calculation was performed using the PMI-Byos (Byonic) software version 4.0-53 (Protein Metrics Inc.). For the calculation the area under the curve (AUC) values of the extracted ion chromatograms (XIC) were used. The relative abundance of the modified peptide was calculated based on the XIC-AUC of the modified species divided by the total peak area of the unmodified and modified peptide. Afterwards the arithmetic mean (n=2) and the standard deviation (SD) was calculated for the duplicates.

TABLE 4

| | | EO Unstressed | | EO Stressed | |
|---|---|---|---|---|---|
| | | Sample | | Sample | |
| | | Rel. Abundance [%] ± SD [%] | | | |
| Mod. | Enzyme | Main | Basic | Main | Basic |
| EO- | LysC | 0.0 ± 0.0 | 0.0 ± 0.0 | 0.0 ± 0.0 | 2.3 ± 0.3 |
| Adduct 1 | | | | | |
| EO- | Trypsin | 0.0 ± 0.0 | 0.0 ± 0.0 | 0.1 ± 0.0 | 3.3 ± 0.0 |
| Adduct 2 | LysC | 0.0 ± 0.0 | 0.0 ± 0.0 | 0.0 ± 0.0 | 3.7 ± 0.1 |

Peptide list:
T19 HC1 255-261 = DTLMASR; L16 HC1 255-280 = DTLMASR-x₁₆-VR
T23 HC2 265-271 = DTLMASR; L17 HC2 265-290 = DTLMASR-x₁₆-VR
T39 HC1 423-445 = WQ-x₉-M-x₉-QK; L31 HC1 421-445 = SRWQ-x₉-M-x₉-QK
T43 HC2 433-455 = WQ-x₉-M-x₉-QK; L32 HC2 431-455 = SRWQ-X₉-M-x₉-QK
* “-x-” serves as placeholder and can stand for any amino acid

Table 4 above shows the results of the unstressed and ethylene oxide stressed BsMAb samples with the mD-UHPLC-MS/MS system: For the characterization of susceptible amino acids for the ethylene oxide adduct formation, stressed and unstressed samples were analyzed with the mD-UHPLC-MS/MS system incorporating a ¹D CEX. The stressed sample was incubated for 7 days at 30° C. with 0.01% ethylene oxide, while the unstressed sample was incubated under the same conditions without ethylene oxide. The main and basic peaks of each sample were analyzed in triplicates and the relative abundance was calculated with the area under the curve (AUC) values of the extracted ion chromatograms (XIC). The relative abundance of the modified peptide was calculated based on the XIC-AUC of the modified peptide divided by the total peak area of the unmodified and modified peptide. The arithmetic mean (n=3) of the relative abundance is listed together with the standard deviation (SD). For the analysis the combined enzyme digestion setup (Trypsin, LysC) of the mD-UHPLC-MS/MS system was used. The data analysis was accomplished with the PMI-Byos (Byonic) software version 4.0-53 (Protein Metrics Inc.) and two separate workflows for Trypsin and LysC. For the peptide identification, MS/MS spectra were used. The precursor mass tolerance was set to 10 ppm and a miss cleavage rate of one was permitted.

### CLAUSES

The following numbered clauses provide some specific embodiments of the invention.

1. A multidimensional liquid chromatograph (LC) system for characterizing a sample of therapeutic antibodies comprising
a digestion module having a digestion column containing an immobilized proteolytic enzyme,
a trapping module having a trapping column for holding the sample after digestion in the digestion module,
a separation module having a separation column for separating analytes in the sample after release of the sample from the trapping column,
a first valve assembly; and
a second valve assembly

wherein the first valve assembly and the second valve assembly are configured such that
the digestion column and the trapping column are fluidly connectable;
the trapping column and the separation column are fluidly connectable; and
the separation module and the digestion module are not fluidly connectable.

2. The multidimensional LC system of clause 1 wherein the first valve assembly comprises a plurality of ports configured so that some combinations of the plurality of ports can be fluidly connected in a first position of the first valve assembly and other combinations of the plurality of ports can be fluidly connected in a second position of the first valve assembly; and
the second valve assembly comprises a plurality of ports configured so that some combinations of the plurality of ports can be fluidly connected in a first position of the second valve assembly and other combinations of the plurality of ports can be fluidly connected in a second position of the second valve assembly

such that
the digestion column and the trapping column are fluidly connected when the first valve assembly is in the second position and the second valve assembly is in a first position;
the trapping column and the separation column are fluidly connected when the second valve assembly is in a second position; and the separation module and the digestion module are not fluidly connected in any combination of positions of the valve assemblies.

3. The multidimensional LC system of clause 2 wherein the separation module comprises a separation pump and the separation pump is fluidly connected to the separation column when the first valve assembly is in the first position and the second valve assembly is in the first position.

4. The multidimensional LC system of any one of the preceding clauses wherein the separation column is selected from a peptide mapping column such a UHPLC column or a HPLC column, a hydrophilic interaction chromatography column, preferably, the separation column is a UHPLC column.

5. The multidimensional LC system of any one of the preceding clauses wherein the separation column has a C18 stationary phase.

6. The multidimensional LC system of claim any one of the preceding clauses wherein the separation column has a length of 100 to 200 mm, such as around 150 mm.

7. The multidimensional LC system of claim any one of the preceding clauses wherein the separation column has a packing material with particle size of 1.0 to 3.0 μm, for example 1.0 to 2.0 μm preferably 1.5 to 2.0 μm.

8. The multidimensional LC system of claim any one of the preceding clauses wherein the separation column has an internal diameter of 1.5 to 5 mm, preferably 1.5 to 2.5 mm such as around 2.1 mm.

9. The multidimensional LC system of claim any one of the preceding clauses wherein the separation contains a C18 stationary phase.

10. The multidimensional LC system of any one of the preceding clauses wherein the trapping column has a length of 5 to 30 mm.

11. The multidimensional LC system of any one of the preceding clauses wherein the trapping column has a packing material with particle size of 1.0 to 3.0 μm, for example 1.0 to 2.0 μm preferably 1.5 to 2.0 μm.

12. The multidimensional LC system of any one of the preceding clauses wherein the trapping column has an internal diameter of 1.5 to 5 mm.

13. The multidimensional LC system of any one of the preceding clauses wherein the trapping column has the same packing material as the peptide mapping column.

14. The multidimensional LC system of any one of the preceding clauses wherein the trapping module comprises a trapping pump and the trapping pump is fluidly connected to the trapping column when the first valve assembly is in the first position and the second valve assembly in the first position.

15. The multidimensional LC system of any one of the preceding clauses wherein the digestion column is selected from a Trypsin immobilized enzyme reactor or a LysC immobilized enzyme reactor.

16. The multidimensional LC system of any one of the previous clauses wherein the digestion module has a first mixer such as static mixer or a zero delay volume T-Piece after the digestion column(s) in the direction of flow.

17. The multidimensional LC system of clause 16 wherein the first mixer is fluidly connected to the trapping pump when the first valve is in the second position.

18. The multidimensional LC system of any one of the preceding clauses wherein the digestion module has a second mixer such as static mixer or a zero delay volume T-Piece before the digestion columns in the direction of flow.

19. The multidimensional LC system of any one of the preceding clauses wherein the digestion module comprising two digestion columns preferably the two digestion columns are connected in parallel.

20. The multidimensional LC system of clause 19 wherein the two digestion columns are connected in parallel such that in use the sample flow is split between the two columns.

21. The multidimensional LC system of clause 19 or clause 20 wherein the two digestion columns are a Trypsin immobilized enzyme reactor and a LysC immobilized enzyme reactor.

22. The multidimensional LC system of any one of the preceding clauses further comprising a reduction module having a reduction column wherein the reduction module and the digestion module are fluidly connected when the digestion module and the trapping module are fluidly connected for example, when the first valve assembly is in the second position.

23. The multidimensional LC system of clause 22 wherein the reduction column contains a C3 or C4 stationary phase, preferably a C4 stationary phase.

24. The multidimensional LC system of any one of the preceding clauses further comprising a fractionation module having a fractionation column.

25. The multidimensional LC system of clauses 24 wherein the fractionation column is selected from an ion exchange chromatography column, size exclusion chromatography column, a hydrophilic interaction chromatography column (HILIC), a hydrophobic interaction chromatography column (HIC) or a proteinA affinity column.

26. The multidimensional LC system of any one of clauses 24 and 25 further comprising a multiple heart cutting valve fluidly connected to the fractionation column and is after the fractionation column in the direction of flow.

27. The multidimensional LC system of clause 26 in so far as it depends on clauses 22 or 23 wherein the multiple heart cutting valve is also fluidly connected to the reduction module and the multiple heart cutting valve is before the reduction module in the direction of flow.

28. The multidimensional LC system of any one of the previous clauses further comprising an analysis module for analyzing the sample after the sample has passed through the separation column.

29. The multidimensional LC system of clause 28 wherein the analysis module comprises: a mass spectrometer such as a high-resolution mass spectrometer (HRMS) or a Single Quad mass spectrometer; an evaporative light scattering detector (ELSD): a UV detector; or a diode array detector (DAD).

30. The multidimensional LC system of any one of the previous clauses wherein the first valve assembly is a 10 port valve with 2 way switching.

31. The multidimensional LC system of any one of the previous clauses wherein the second valve assembly is a 10 port valve with 2 way switching.

32. A multidimensional LC process for analyzing a sample of therapeutic antibodies comprising;
providing a sample of antibodies to be analyzed,
introducing the sample to a digestion module having a digestion column containing an immobilized proteolytic enzyme, such that the enzyme proteolytically cleaves the antibodies in the sample to produce a digested sample,
introducing the digested sample to a trapping column for holding the digested sample,
releasing the digested sample from the trapping column and introducing the sample to a separation module having a separation column for separating analytes in the sample,
wherein the sample is flowed through the digestion module, trapping module and separation module using solvent and one or more pumps and
wherein a first valve assembly and a second valve assembly are used to:
provide fluid connection between the digestion module and the trapping module when the sample is digested and trapped on the trapping column; and
provide fluid connected between the trapping column and separation column when the digested sample is released from the trapping column and introduced onto the separation column; and
prevent fluid connection between the separation column and digestion column

33. The multidimensional LC process according to clause 32 wherein the first valve assembly and the second valve assembly each have a first and a second position
wherein when the sample is digested and introduced onto the trapping column the first valve assembly is in the second position and the second valve assembly in the first position and
when the sample is released from the trapping column and introduced onto the separation column the second valve assembly is in the second position.

34. The multidimensional LC process of clause 33 wherein when the sample is trapped on the trapping column after digestion, the first valve assembly is moved into the first position a trapping pump of the trapping module flushes solvent through the trapping column before the second valve assembly is moved to the second position.

35. The multidimensional LC process of clause 34 wherein the trapping pump of the trapping module is used to adjust the solvent whilst the sample is trapped on the trapping column, for example when the solvent is a water acetonitrile mixture, the acetonitrile concentration is adjusted to from 1 to 5 wt %.

36. The multidimensional LC process of clause 35 wherein the trapping pump provides a flow rate of from 0.20 to 2.5 mL/min.

37. The multidimensional LC process of any one of clauses 32 to 36 wherein the solvent used to pass the sample through the separation column is water with acetonitrile, preferably the acetonitrile concentration is from 1 to 5 wt %.

38. The multidimensional LC process of any one of clauses 32 to 37 wherein the trapping column has a column temperature of from 20 to 70° C., preferably from 30 to 50° C.

39. The multidimensional LC process of any one of clauses 32 to 28 wherein the trapping column and the separation column are maintained at the same temperature such as from 30 to 50° C.

40. The multidimensional LC process of any one of clauses 32 to 39 further comprising a reduction step prior to the digestion step.

41. The multidimensional LC process of clause 40 wherein the reduction step is carried out by introducing the sample into a reduction module comprising a reduction column and reducing the sample by flowing a solvent containing a reduction agent through the reduction column whilst the sample is on the reduction column.

42. The multidimensional LC process of clause 40 or clause 41 wherein the reducing agent is Tris-(2-carboxyethyl)-phosphin or dithiothreitol.

43. The multidimensional LC process of any one of clauses 32 to 42 further comprising a fractionation step prior to the digestion step and, if present, prior to the reduction step.

44. The multidimensional LC process of any one of clauses 32 to 43 further comprising the step of analyzing the fractions of the sample as they flow off the separation column by mass spectrometry.

1. A multidimensional liquid chromatograph (LC) system for characterizing a sample of therapeutic antibodies comprising
a digestion module having a digestion column containing an immobilized proteolytic enzyme,
a trapping module having a trapping column for holding the sample after digestion in the digestion module,
a separation module having a separation column for separating analytes in the sample after release of the sample from the trapping column,
a first valve assembly; and
a second valve assembly
wherein the first valve assembly and the second valve assembly are configured such that
the digestion column and the trapping column are fluidly connectable;
the trapping column and the separation column are fluidly connectable; and
the separation module and the digestion module are not fluidly connectable.

2. The multidimensional LC system of claim 1 wherein the first valve assembly comprises a plurality of ports configured so that some combinations of the plurality of ports can be fluidly connected in a first position of the first valve assembly and other combinations of the plurality of ports can be fluidly connected in a second position of the first valve assembly; and
the second valve assembly comprises a plurality of ports configured so that some combinations of the plurality of ports can be fluidly connected in a first position of the second valve assembly and other combinations of the plurality of ports can be fluidly connected in a second position of the second valve assembly
such that
the digestion column and the trapping column are fluidly connected when the first valve assembly is in the second position and the second valve assembly is in a first position;
the trapping column and the separation column are fluidly connected when the second valve assembly is in a second position; and
the separation module and the digestion module are not fluidly connected in any combination of positions of the valve assemblies.

3. The multidimensional LC system of claim 1 wherein the separation column is selected from a peptide mapping column such a UHPLC column or a HPLC column, a hydrophilic interaction chromatography column, preferably, the separation column is a UHPLC column.

4. The multidimensional LC system of claim 1 wherein the trapping column has the same packing material as the peptide mapping column.

5. The multidimensional LC system of claim 1 wherein the trapping module comprises a trapping pump and the trapping pump is fluidly connected to the trapping column when the first valve assembly is in the first position and the second valve assembly in the first position.

6. The multidimensional LC system of claim 1 wherein the digestion column is selected from a Trypsin immobilized enzyme reactor or a LysC immobilized enzyme reactor.

7. The multidimensional LC system of claim 1 wherein the digestion module has a first mixer such as static mixer or a zero delay volume T-Piece after the digestion column(s) in the direction of flow preferably wherein the first mixer is fluidly connected to the trapping pump when the first valve is in the second position.

8. The multidimensional LC system of claim 1 wherein the digestion module comprising two digestion columns preferably the two digestion columns are connected in parallel.

9. The multidimensional LC system of claim 8 wherein the two digestion columns are connected in parallel such that in use the sample flow is split between the two columns preferably wherein the two digestion columns are a Trypsin immobilized enzyme reactor and a LysC immobilized enzyme reactor.

10. The multidimensional LC system of claim 1 further comprising a reduction module having a reduction column wherein the reduction module and the digestion module are fluidly connected when the digestion module and the trapping module are fluidly connected such as when the first valve assembly is in the second position.

11. The multidimensional LC system of claim 1 further comprising a fractionation module having a fractionation column optionally wherein the fractionation column is selected from an ion exchange chromatography column, size exclusion chromatography column, a hydrophilic interaction chromatography column (HILIC), a hydrophobic interaction chromatography column (HIC) or a proteinA affinity column.

12. The multidimensional LC system of claim 11 further comprising a multiple heart cutting valve fluidly connected to the fractionation column and after the fractionation column in the direction of flow.

13. The multidimensional LC system of claim 1 further comprising an analysis module for analyzing the sample after the sample has passed through the separation column.

14. A multidimensional LC process for analyzing a sample of therapeutic antibodies comprising;
providing a sample of antibodies to be analyzed,
introducing the sample to a digestion module having a digestion column containing an immobilized proteolytic enzyme, such that the enzyme proteolytically cleaves the antibodies in the sample to produce a digested sample,
introducing the digested sample to a trapping column for holding the digested sample,
releasing the digested sample from the trapping column and introducing the sample to a separation module having a separation column for separating analytes in the sample,
wherein the sample is flowed through the digestion module, trapping module and separation module using solvent and one or more pumps and
wherein a first valve assembly and a second valve assembly are used to:
provide fluid connection between the digestion module and the trapping module when the sample is digested and trapped on the trapping column; and
provide fluid connected between the trapping column and separation column when the digested sample is released from the trapping column and introduced onto the separation column; and
prevent fluid connection between the separation column and digestion column

15. The multidimensional LC process according to claim 14 wherein the first valve assembly and the second valve assembly each have a first and a second position
wherein when the sample is digested and introduced onto the trapping column the first valve assembly is in the second position and the second valve assembly in the first position and
when the sample is released from the trapping column and introduced onto the separation column the second valve assembly is in the second position.

16. The multidimensional LC process of claim 14 further comprising a reduction step prior to the digestion step optionally wherein the reduction step is carried out by introducing the sample into a reduction module comprising a reduction column and reducing the sample by flowing a solvent containing a reduction agent through the reduction column whilst the sample is on the reduction column.

17. The multidimensional LC process of claim 14 further comprising a fractionation step prior to the digestion step and, if present, prior to the reduction step.

18. The multidimensional LC process of claim 14 further comprising the step of analyzing the fractions of the sample as they flow off the separation column by mass spectrometry.
